(19) United States
(12) Patent Application Publication
(10) Pub. No.: US 2012/0015211 A1
(43) Pub. Date: Jan. 19, 2012

(54) METHODS FOR THE FABRICATION OF NANOSTRUCTURES

(76) Inventors: Zhiyong Gu, North Chelmsford, MA (US); Qingzhou Cui, Lowell, MA (US); Julie Chen, Wilmington, MA (US)

(21) Appl. No.: 13/256,491

(22) PCT Filed: Mar. 16, 2010
(86) PCT No.: PCT/US10/27521

§ 371 Date: Sep. 14, 2011

Related U.S. Application Data
(60) Provisional application No. 61/160,534, filed on Mar. 16, 2009.
(60) Provisional application No. 61/234,529, filed on Aug. 17, 2009.

(51) Int. Cl. B32B 15/01; C25D 5/00

(52) U.S. Cl. 428/651; 205/85; 428/650; 428/653; 428/652; 977/890; 977/700

(57) ABSTRACT

The present invention relates to methods of fabricating nanostructures using a replacement reaction. In a preferred embodiment, metal particles in an inert atmosphere undergo a replacement reaction to form a layer on the metal particle which is removed to form a high surface area nanostructure. A preferred embodiment includes the fabrication of heater elements, powders and heater assemblies using the nanostructures.

### CROSS-REFERENCE TO RELATED APPLICATION

This application claims the benefit of U.S. Provisional Application No. 61/160,534 filed Mar. 16, 2009, and U.S. Provisional Application No. 61/234,529 filed Aug. 17, 2009.

### STATEMENT REGARDING FEDERALLY SPONSORED RESEARCH OR DEVELOPMENT

The invention was made with support from Grant CMMI-0738253 from the U.S. National Science Foundation. The United States Government has certain rights in the invention.

### BACKGROUND OF THE INVENTION

Methods for synthesizing novel nanostructures have attracted great attention. Galvanic replacement reaction has proven to be such an efficient method that many nanostructures have been fabricated including nanobox, nanotube, nanorattle structures. Examples of galvanic replacement reaction have been reported on silver (Ag) and palladium (Pd) nanoparticle templates. It is difficult to achieve galvanic replacement reaction on non-inert metals, in part due to the oxide layer on those metals that can prevent the replacement from occurring.

A continuing need exists for further improvements in the manufacture of nano-scale structures for a variety of applications.

### SUMMARY OF THE INVENTION

The present invention relates to fabrication methods for high yield and high volume production of metallic nanostructures. Preferred embodiments utilize a metal template in a replacement reaction to produce nanostructures for many applications. Aluminum (Al), for example, an active metal material, can reduce many less active metal ions. However, the oxide layer that forms readily on Al surfaces can prevent Al from undergoing many potential reactions. A preferred embodiment uses Al as a template to form generally spherical or cube shaped particles. Alternatively, other active metal nanoparticles such as Ti, In, Cr, Mn and Zn can be used as templates for the galvanic replacement reaction in a controlled environment. The fabrication of aluminum-nickel (Al—Ni) core-shell nanoparticles and porous Ni nano-shell particles through sacrificing Al nanoparticle templates, for example, can be implemented utilizing the galvanic replacement reaction.

Nano-shell nanostructures are useful due to their greater surface area/weight ratio in contrast to that of solid nanoparticles. Potential applications include new, highly-efficient catalyst materials with very large surface area/weight ratio. Currently the most widely used method for making nano-shell structures is to remove a dissolvable core part from core-shell nanostructures; however, this type of method normally involves significantly more steps, including core growth, surface modification, metal shell formation, and then core dissolution.

If the galvanic replacement is quenched at a certain stage, a hetero Al/Ni core-shell nanostructure can result from the galvanic replacement process. These heterostructures can be used as nanoscale heating sources. Al, as an active metal, can form an alloy with many other metals such as nickel, with vigorous heat production when ignited. Titanium can also be used to form a Ti—Ni core-shell structure. The exothermic reaction has been used to construct a heating source with fine spatial control because of its unique properties including versatile ignition methods and products being electrically conductive. The hollow structure can be processed to form powders which can be ignited to heat materials or components. The powders can also be processed by compaction or spinning to form larger heater elements. These heater elements (or the powder form) can be mounted (or deposited) on substrates in heater assemblies or arrays with other electrical and/or optical components (lenses, optical fibers). The heating powder can also be inserted or dispersed in fluids, solders or polymers as a heat source.

According to one embodiment, the fabrication of aluminum-cobalt (Al—Co) core-shell nanoparticles and porous cobalt nano-shell particles through sacrificing Al nanoparticle templates can be implemented utilizing the galvanic replacement reaction.

According to yet another embodiment, the fabrication of aluminum-iron (Al—Fe) core-shell nanoparticles and porous iron nano-shell particles through sacrificing Al nanoparticle templates can be implemented using the galvanic replacement reaction.

According to yet another embodiment, a catalyst material and a method of catalyzing a reaction utilize a nano-shell material of the present invention. In one embodiment, a hydrolysis reaction using a fuel, such as sodium borohydride, is catalyzed using a nano-shell catalyst material, such as a nickel nano-shell or a cobalt nano-shell, to generate high-purity hydrogen. The nano-shell catalyst material of the present invention can be incorporated into a fuel cell power system, such as a hydrogen-on-demand fuel cell system.

According to yet another embodiment, the catalyst nanoparticle material, such as a nano-shell material, is embedded in a hydrogel carrier material.

For the purposes of this application, the terms nanostructure, nanoparticle, nano-shell, etc, refer to structures having a feature size (such as diameter or thickness) that is less than 200 nm. The template geometry can be spheres, cubes or wires, for example, that can undergo a partial or complete replacement reaction to generate a structure with an internal cavity.

### BRIEF DESCRIPTION OF THE DRAWINGS

Various aspects of at least one embodiment of the present invention are discussed below with reference to the accompanying figures. In the figures, which are not intended to be drawn to scale, each identical or nearly identical component that is illustrated in the various figures is represented by a like numeral. For purposes of clarity, not every component may be labeled in every drawing. The figures are provided for the purposes of illustration and explanation and are not intended as a definition of the limits of the invention. In the figures:

FIG. 1A is a schematic illustration of cross-section of nanoparticles during the galvanic replacement of Al by Ni, summarizing how hollow nanostructures evolve from aluminum nanoparticles to pure nickel nanoshell at different stage of the reaction;

FIG. 1B is a galvanic cell formed on a single nanoparticle, dissolving inner Al core and depositing Ni on outer shell with electrons flow confined in the nanoparticles;

FIG. 2A is an SEM image of Al nanoparticle template seeds, and the inset is a TEM image of the nanoparticles;

FIG. 2B is an SEM image of nickel nano-shell particles, and inset is high-magnification SEM image;

FIG. 3A illustrates the reaction kinetics of hydrogen generation at different temperatures from the nickel nano-shells fabricated from 120 nm Al nanoparticle template;

FIG. 3B is an Arrhenius plot (ln k versus the reciprocal absolute temperature 1/T) for the hydrolysis of sodium borohydride catalyzed by nickel nano-shells;

FIG. 4 graphically illustrates the surface area measured by BET on porous nanoparticles, and the surface area is calculated to be 28.88 m²/g;

FIGS. 5A and 5B show an Al/Ni hetero-structure including 5A) low magnification SEM image; and 5B) a high magnification SEM image for a single nanoparticle;

FIGS. 6A to 6D illustrate the galvanic replacement process on Al nanoparticles, from Al nanoparticle template seeds (FIG. 6A), to intermediate Al—Ni hetero-structures (FIGS. 6B and 6C), to Ni nano-shell particles (FIG. 6D);

FIG. 7A is an x-ray diffraction analysis of intermediate-stage Al—Ni hetero-structures, with the lower line showing an early stage of the galvanic replacement process and the upper line showing a late stage of the galvanic replacement process;

FIG. 7B is a plot of atomic emission spectroscopy (AES) measurements of a Al—Ni heterostructure showing the Al and Ni content over time;

FIG. 8A is a FE-SEM image of porous nickel nanoparticles on a silicon support;

FIG. 8B is an EDS (energy dispersive x-ray spectroscopy) image showing the elemental distribution of nickel;

FIG. 8C is an EDS image showing the elemental distribution of silicon;

FIG. 8D shows the EDS spectrum for nickel and silicon;

FIG. 9A is a SEM image of cobalt nano-shell particles formed on aluminum nano-particle template seeds;

FIG. 9B shows an element analysis by EDS for Co porous nanoparticles fabricated from the galvanic replacement reaction;

FIG. 9C is a TEM image of cobalt nano-shell particles fabricated from the galvanic replacement reaction using Al template nanoparticles;

FIG. 10A is a SEM image of iron nano-shell particles formed on aluminum nano-particle template seeds;

FIG. 10B shows an element analysis by EDS for Fe porous nano-shell fabricated from the galvanic replacement reaction;

FIG. 10C is a TEM image of iron nano-shell particles fabricated from the galvanic replacement reaction using Al template nanoparticles;

FIG. 11 illustrates the hydrolysis reaction for sodium borohydride (NaBH₄) using a porous nanoparticle catalyst;

FIG. 12 is a schematic illustration of a fuel cell system using a nano-shell catalyst material to generate hydrogen;

FIG. 13 is a diagram illustrating the setup for hydrogen (H₂) generation and collection for nickel nanoparticles, nickel nano-shells and cobalt nano-shells;

FIG. 14 illustrates catalyst nanoparticles embedded in a hydrogel material;

FIG. 15 is a SEM image of microsized, porous copper particles fabricated from the galvanic replacement reaction;

FIG. 16 is a SEM image of connected silver nanoparticles fabricated from the galvanic replacement reaction;

FIG. 17 is a SEM image of platinum-based materials formed fabricated from the galvanic replacement reaction;

FIG. 18 is a SEM image of gold nano-shell particles fabricated from the galvanic replacement reaction;

FIG. 19A illustrates catalytic activities obtained from solid nickel and hollow nickel nanoparticles, respectively, at 25° C. Linear fitting was observed before the reactant was depleted, from which the H₂ generation rate are calculated to be 37.5 and 79.7 ml/min/g for solid and hollow nickel nanoparticle, respectively;

FIG. 19B illustrates catalytic activities obtained from solid cobalt and hollow cobalt nanoparticles, respectively, at 25° C. The H₂ generation rates are calculated to be 1080 and 1544 ml/min/g for solid and hollow cobalt nanoparticles, respectively;

FIG. 20A illustrates catalytic activities obtained at different temperatures of 20, 25, 30, and 41° C. when 10 mg nickel hollow nanoparticles were used to catalyze the sodium borohydride hydrolysis reaction;

FIG. 20B illustrates the Arrhenius plot (ln k vs. the reciprocal absolute temperature 1/T) for the hydrolysis of NaBH₄ using nickel hollow particles as catalysts, from which the activation energy is calculated to be 52.3 kJ/mol;

FIG. 21A illustrates catalytic activities obtained at different temperatures of 15, 25, 30.5, and 35° C. when 10 mg cobalt hollow nanoparticles were used to catalyze the sodium borohydride hydrolysis reaction;

FIG. 21B illustrates the Arrhenius plot (ln k vs. the reciprocal absolute temperature 1/T) for the hydrolysis of NaBH₄ using cobalt nano-hollows as catalysts and the activation energy is calculated to be 62.7 kJ/mol; and

FIGS. 22A and 22B are perspective views, respectively, schematically illustrating microscale joining of components on planar flexible or curved substrates using nanoheater structures;

FIG. 23A shows an equiaxed microstructure of aluminum ultrasonically consolidated from a fine aluminum powder (<7˜15 μm, 99.95%) at 573 K under a normal pressure of 150 MPa and duration of 1.0 s;

FIG. 23B shows an Al—Ni consolidate produced at 150° C. for 1 s;

FIG. 24 is a flow chart illustrating one embodiment of a combined experimental and modeling approach for providing nanoheater materials for microscale joining;

FIG. 25 is a schematic illustration of ultrasonic powder consolidation;

FIG. 26 shows a schematic of a typical electrospinning setup;

FIG. 27 is an SEM image of a typical electrospun random fiber orientation mat on a flat target, PEO 8 wt % in ethanol and water;

FIG. 28 is a TEM image of an electrospun nanofiber with embedded PTA nanoparticles;

FIGS. 29A and 29B are SEM images of a UPC consolidated Al—Ni core-shell nanoparticle sample before laser ignition (FIG. 29A) and after laser scanning and ignition (FIG. 29B), where the ignition occurred in laser scanned sections, while those sections without laser scanning were not ignited; and

FIG. 30 illustrates the temperature profile for the ignition of UPC consolidated Al—Ni nanoparticles.

### DETAILED DESCRIPTION OF THE INVENTION

This application claims the benefit of U.S. Provisional Application No. 61/160,534, filed Mar. 16, 2009, and U.S. Provisional Application No. 61/234,529, filed Aug. 17, 2009, the entire teachings of which are incorporated herein by reference.

Galvanic replacement reaction was performed in an inert gas-filled chamber such as a glove box. In a typical replacement reaction, a fixed amount of Al nanoparticle templates were placed in a solution dissolved with NiSO₄, NH₄Cl, and sodium citrate. The mixture was kept in the glove box to prevent an oxide layer from forming on the Al templates. Over time, the galvanic replacement reaction results in the Al being replaced by Ni (in this case) from the solution (aqueous). The resulting nanoparticles were separated and cleaned with nanopure water for 5 times and ethanol for 2 times by centrifuging at 3000-5000 rpm, and then dried in vacuum oven overnight. By controlling the replacement reaction parameters, different heterostructures can be fabricated. After the replacement reaction is completed, nickel nano-shell particles can be produced.

Cobalt and iron nano-shell particles can also be fabricated using a similar process, with cobalt (II) chloride hexahydrate (CoCl₂.6H₂O) and ferrous sulfate heptahydrate (FeSO₄.7H₂O) as precursors, respectively.

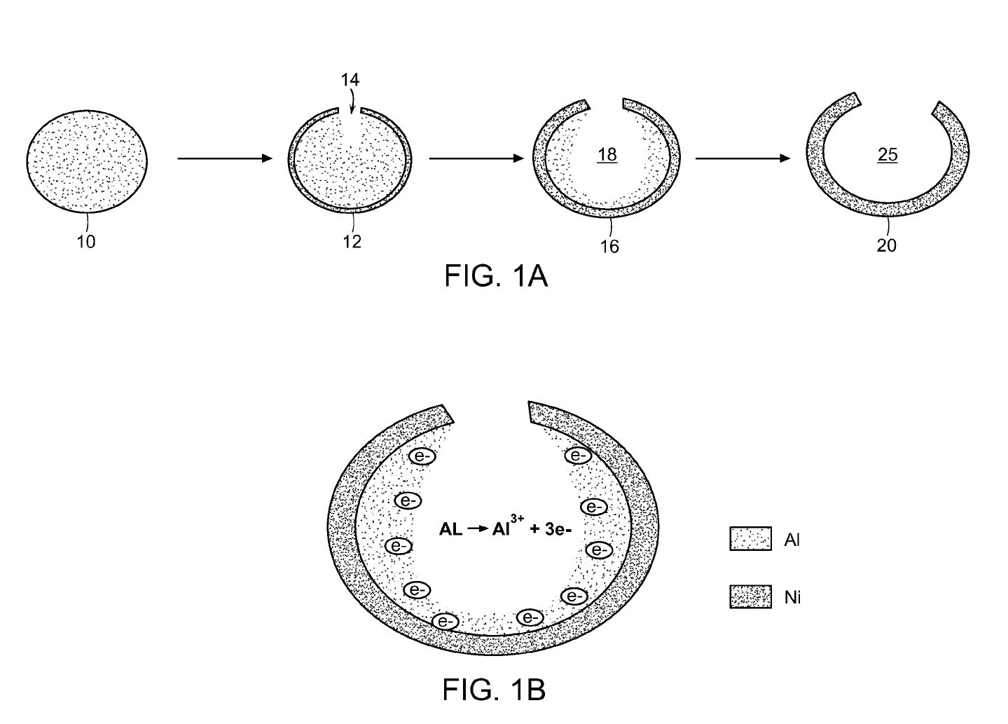

The galvanic replacement mechanism is illustrated in FIG. 1A, by the reaction: Ni²⁺(aq)+Al(s)→Ni(s)+Al³⁺(aq), where nanoparticle development during the galvanic replacement is schematically illustrated. Hollow nanostructures evolve from aluminum nanoparticles 10 to pure nickel nano-shells 20 at different stages of the reaction. A nickel outer shell 12 is grown around the particle 10 while the reaction occurs through opening 14 to form a cavity 18 which expands to the hollow 25 structure. In FIG. 1B, it is illustrated in more detail that a galvanic cell is formed on a single nanoparticle, dissolving inner and Al core and depositing Ni on outer shell with electron flow confined in the nanoparticles.

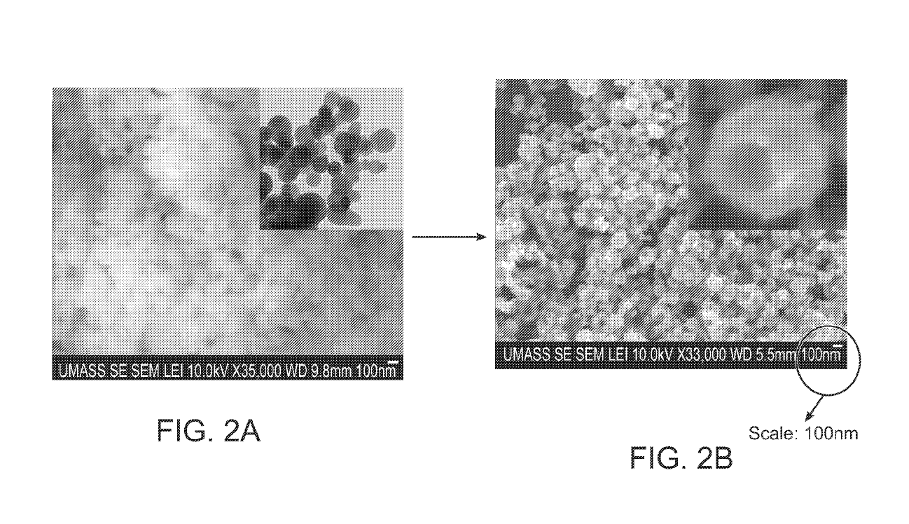

The SEM and TEM images of the template aluminum nanoparticles are shown in FIG. 2A. The nanoparticles are relatively uniform with average diameter around 120 nm. Our current study has lead to final product (nickel nano-shells) in the size range of 100-200 nm as demonstrated by the SEM images in FIG. 2B. The porous nickel nano-shell particles fabricated are structurally robust and associated with large surface area from its unique geometry, which shows great potential for many applications especially as catalysts.

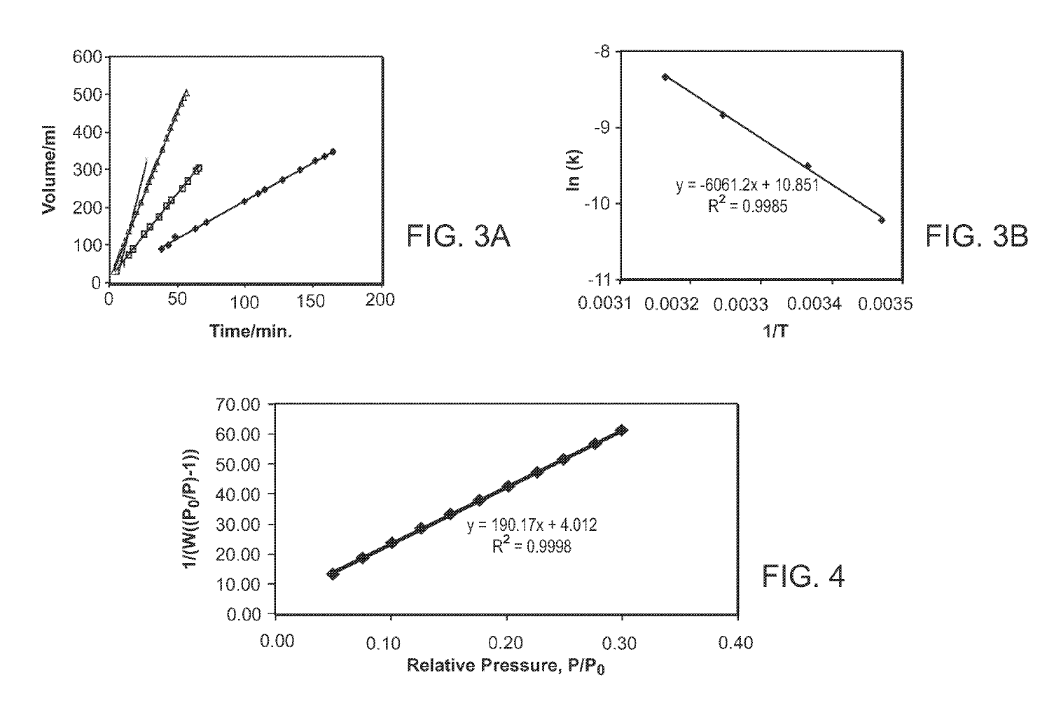

Nickel nano-shells can be used as catalysts for hydrogen generation from sodium borohydride hydrolysis reaction. This process can be used for energy production such as in a fuel cell. The hydrogen generation and collection were performed on a gas displacement apparatus. Typically, an amount of nickel nano-shell particles was placed into a reaction chamber that is filled with NaOH solution dissolved with a fixed amount of sodium borohydride (the mass is corresponding to generation of a maximum H2 gas at room temperature and pressure). Once the solution reached thermal equilibrium with the water bath, the nickel nano-shell catalyst was added to the solution, which is dispersed in the solution. The reaction chamber was then sealed, with a small tube transferring the evolved hydrogen to a water displacement graduated cylinder. The catalyst usually needs some time to be active and start to generate H2 smoothly afterward. In FIG. 3A, demonstrate that the nickel nano-shell is highly active for catalyzing the sodium borohydride reaction at temperatures from 15 to 45° C. From the Arrhenius plot as shown in FIG. 3B, the activation energy is calculated to be 50.37 kJ/mol, which is significantly lower than that reported in literature on nickel powders. Please note that the activation energy shown above is based on nickel nano-shells originated from Al nanoparticles with diameters of about 120 nm. Currently smaller diameter Al nanoparticles such as 50 nm are being used to fabricate nickel nano-shells with smaller diameter. It is expected that the smaller diameter the nickel nano-shells, the larger the surface area, and correspondingly the higher catalytic efficiency and the lower activation energy for the hydrogen generation reaction.

A multipoint BET plot for the Ni hollow nano-shells is shown in FIG. 4. From the plot, calculating the surface area for the nanoshells yields a value of 28.88 m²/g. For 120 nm nickel spherical nanoparticles, assuming they are spherical, the surface area is estimated to be 6.42 m²/g. The significant improvement in surface area/weight ratio for the nickel nano-shells is attributed to two factors: 1) the unique shell geometry provides a larger surface area/weight ratio compared to a spherical structure; 2) the surface roughness of nickel nano-shells further increases its surface area. In one embodiment, generally, the surface area of the hollow nano-shells of the invention is greater than about 28 m²/g, and can be in a range from about 30 to 60 m²/g. The roughness of the surface can be determined by fractal dimension by gas adsorption. A thermodynamic method, the Neimark-Kiselev (NK) method can be used to calculate the fractal property of the nickel nano-shells (NK Method Fractal Dimension) (for pores from 4 A to 100 A) to be 2.774, which is consistent with our observation of rough surface for the nickel nano-shells by SEM imaging. The amorphous nickel structure during shell formation process can contribute to the surface roughness. As mentioned before, if a smaller diameter Al nanoparticle seed is used for the replacement reaction, smaller diameter nickel nano-shell particle can be obtained with even higher surface area than the value reported above.

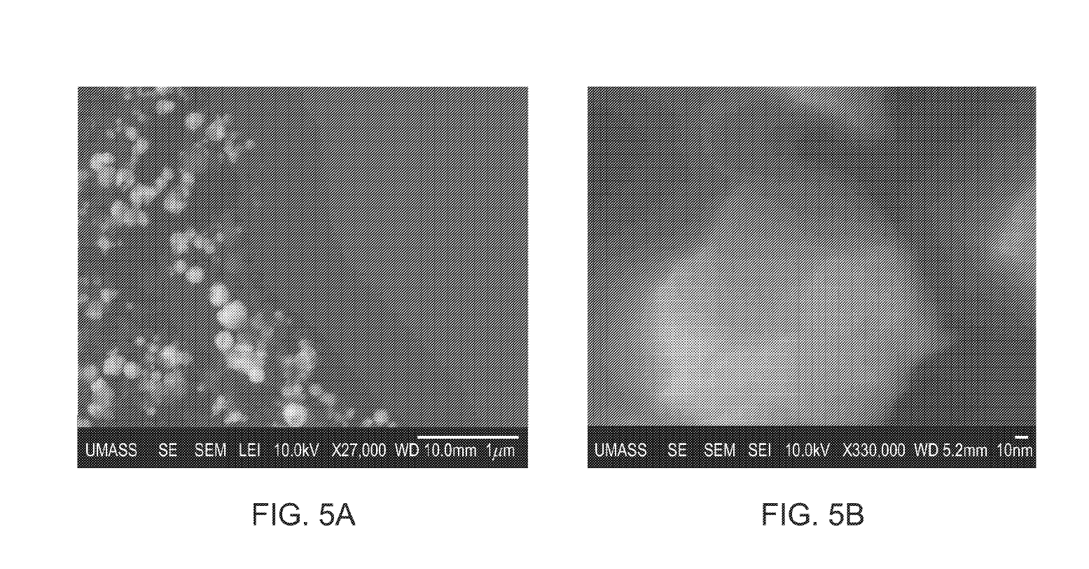

Analysis shows that if the replacement reaction is quenched at a certain stage, a hetero-structure with a certain Al/Ni ratio could be formed (see FIGS. 5A and 5B). Those hetero-structures can be used as nanoheating sources as described in greater detail in U.S. application Ser. No. 12/375,823 filed on Jan. 30, 2009 and published in Application No. PCT/US2007/017524 filed on Aug. 7, 2007, the entire contents of these applications being incorporated herein by reference.

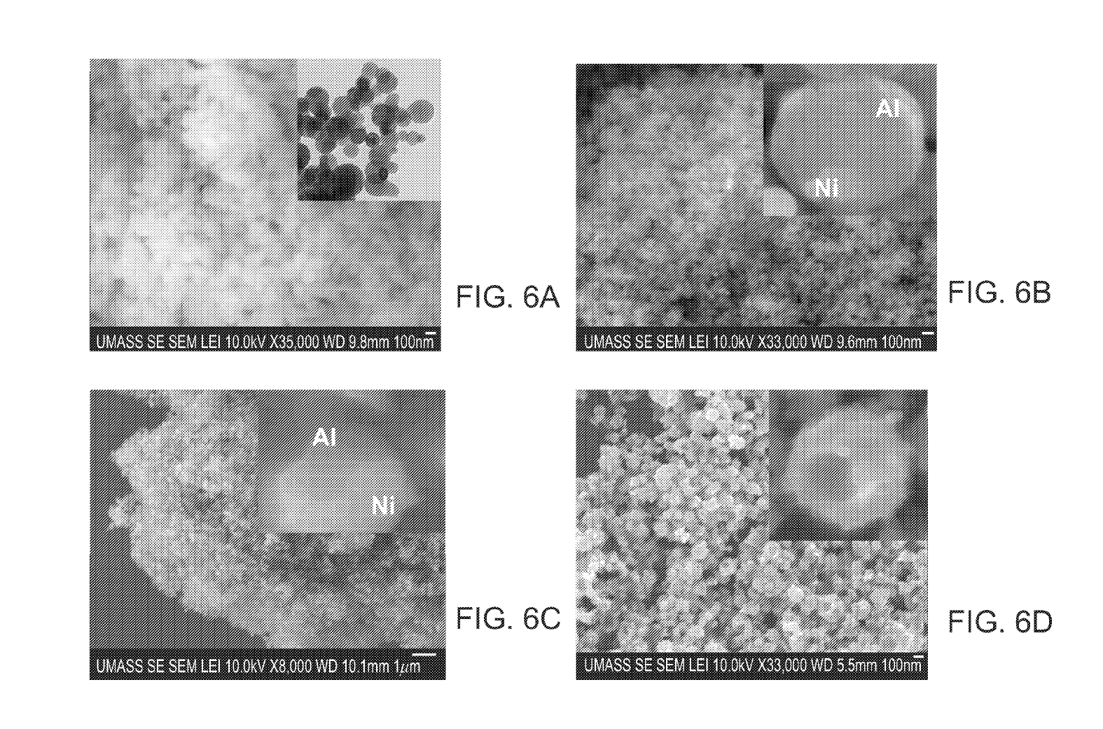

FIGS. 6A to 6D illustrate the galvanic replacement process on Al nanoparticles, from Al nanoparticle template seeds (FIG. 6A), to intermediate Al—Ni hetero-structures (FIGS. 6B and 6C), to Ni nano-shell particles (FIG. 6D).

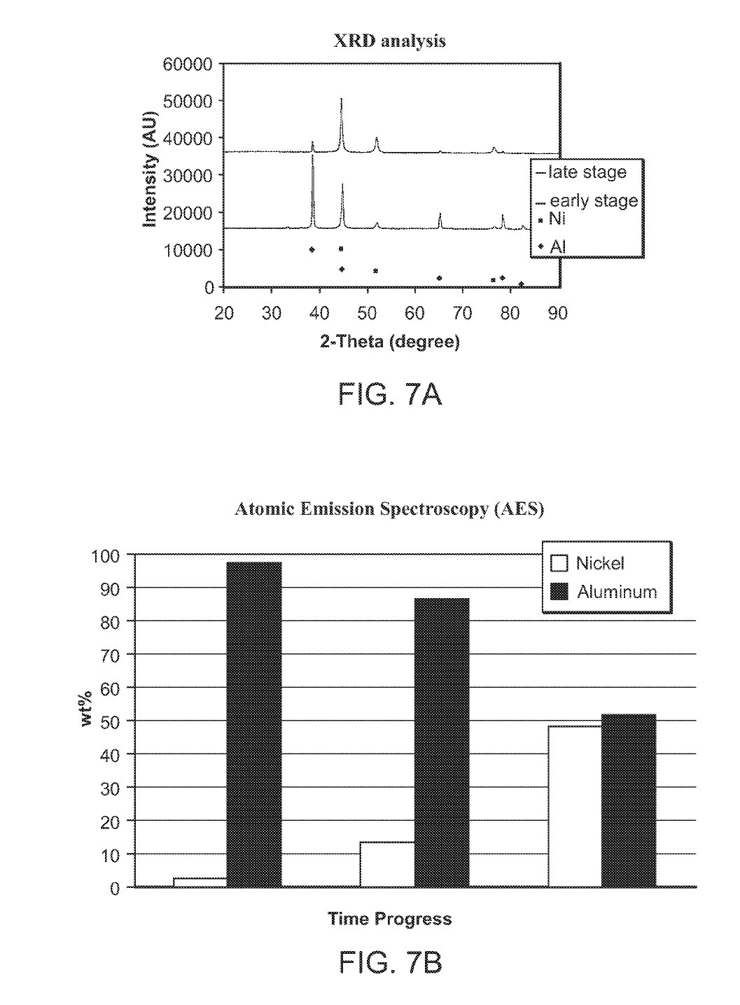

FIG. 7A is an x-ray diffraction analysis of intermediate-stage Al—Ni hetero-structures. The lower line shows the analysis at an early stage of the galvanic replacement process and the upper line shows the analysis at a late stage of the galvanic replacement process. FIG. 7B is a plot of atomic emission spectroscopy (AES) measurements of an Al—Ni hetero-structure during the galvanic replacement process showing the changes in Al and Ni content over time.

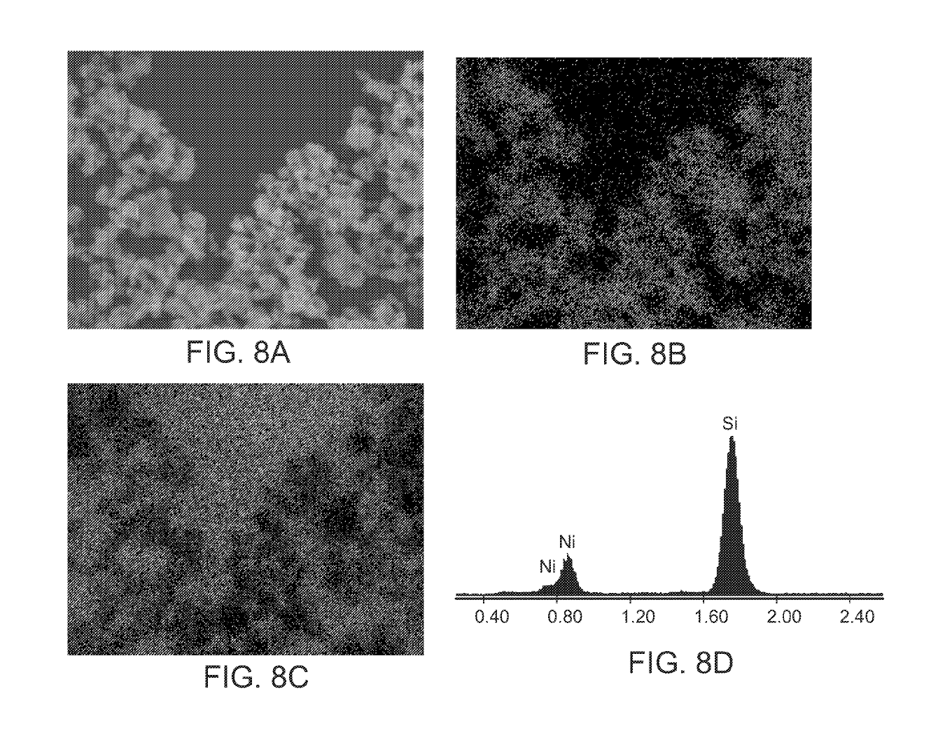

FIG. 8A is a FE-SEM image of porous nickel nanoparticles on a silicon support. FIG. 8B is an EDS (energy dispersive x-ray spectroscopy) image showing the elemental distribution of nickel and FIG. 8C is an EDS image showing the elemental distribution of silicon. FIG. 8D shows the EDS spectrum for nickel and silicon.

Thus, the galvanic replacement reaction is used for non-noble metal nanostructure fabrication using Al nanoparticles as templates. The facile reaction was performed in an inert gas-filled chamber at room temperature. Nickel porous nano-shell particles were obtained through a galvanic replacement reaction mechanism. Porous nanoparticles can be used as catalyst materials due to their high surface area and stability. These nickel nanoparticles used with sodium borohydride hydrolysis reaction for hydrogen generation and fuel cell related applications. Compared to bulk material, the activation energy is lowered significantly from 70 to 50 kJ/mol. Its high catalyzing activity is based on the high surface area per unit of weight. These porous nano-shells can also be used in other catalytic reactions that use Nickel or Nickel alloys as catalysts. The intermediate product Al/Ni core-shell heterostructure can be used as nanoheating sources for advanced materials processing, nanomanufacturing, thermal manufacturing, MEMS/NEMS, lab-on-a-chip, microfluidics, and biomedical applications such as hyperthermia for killing cancer cells.

According to certain embodiments of the present invention:

1) Aluminum nanoparticles are used as templates for galvanic replacement reaction for fabricating nanostructures;
2) The facile method from galvanic replacement reaction is easy to scale up for massive production of nanostructures;
3) Nickel porous nano-shell particles obtained are roughly 100-200 nm in diameter;
4) Due to the low cost and large specific surface area of the nickel porous nano-shell particles, the structures can be used for use as novel catalyst materials, including a more efficient alternative to current nickel catalysts;
5) The nickel porous nanoparticles can be used for a catalyst for sodium borohydride hydrolysis in hydrogen generation and fuel cells;
6) The nickel catalyst shows stability in alkaline solution;
7) The intermediate product Al/Ni heterostructure can be used to construct nanoheating sources for advanced materials processing, nanomanufacturing, thermal manufacturing, MEMS/NEMS, lab-on-a-chip, microfluidics, and biomedical applications such as hyperthermia for killing cancer cells.

According to one fabrication method for porous Ni nano-shells, Al nanoparticles were packed in a sealed glass bottle in argon environment. The Al particles were purchased from Novacentrix Corp. (Austin, Tex.). Because the Al nanoparticles are very active in air, they were transferred immediately to an argon gas-filled glove box (PLAS LABS, Model 818-GB) upon arrival and the galvanic replacement reaction was performed in the glove box. A replacement solution containing 0.23 M NiSO₄ (available from Acros Organics), 1.87 M NH₄Cl (Acros Organics), and 0.44 M sodium citrate (Fisher Scientific) was vacuum-degassed before putting into the glove box. In a typical replacement reaction, 0.50 g Al template particles were mixed with 15 ml of the replacement solution. The mixture was left in the glove box for reaction, and samples at different stages of reaction were taken out for characterization. The reaction between Al and water is strongly inhibited due to the presence of nickel ions, which tend to react with Al quickly. The resulted samples were cleaned with nanopure water (≧17.5 MΩ cm⁻¹, Barnstead Nanopure Water Purification System) for 5 times and with ethanol (Fisher Scientific) for 3 times through ultrasonic dispersion and centrifuge (at 5000 rpm) cycles. The washed samples were dried in a vacuum oven for 24 hours and kept in a glove box before imaging and property characterization.

Scanning electron imaging was performed on a JOEL 7401F field emission-scanning electron microscopy (FE-SEM). The sample was made by drop casting nanoparticle dispersion (in ethanol) onto conductive silicon wafer, which was attached onto sample stub by carbon tape. To enhance conductivity, Electrodag 502 (Ted Pella, Inc.) was used. The JOEL 7401F FESEM was also equipped with energy dispersive x-ray spectrometer (EDS), which was used for element analysis and element distribution mapping analysis. Transmission electron microscope imaging was performed with a Philips EM400 transmission electron microscope (TEM) operated at 100 kV. Samples were made by drop casting the nanoparticle dispersion onto copper grids coated with Formvar and carbon film (200 mesh, SPI, West Chester, Pa.). Multipoint BET for the metal nano-shell particles were performed on an Autosorb-3B from Quantachrome Instruments. XRD analysis was performed on a High Power Rotating Anode X-Ray Powder Diffractometer (Rigaku RU 300) (Cu Kα radiation, λ=1.540598 Å).

Co and Fe nano-shell particles can be prepared in substantially the same manner as described above in connection with the Ni particles, only with nickel precursor replaced with Cobalt (II) chloride hexahydrate (CoCl₂.6H₂O) (Acros Organics) for fabricating Co particles, and ferrous sulfate heptahydrate (FeSO₄.7H₂O) (Fisher Scientific), for fabricating Fe particles.

Due to the high polydispersity of the original template Al nanoparticles, the size of the nanoparticles is also polydispersed. The non-uniformity of the interior domain is consistent to other observations on Au nanoshells fabricated through the galvanic replacement. Using a higher quality template material, such as monodispersed nanoparticles, can provide more fine control in the shell size of the resulting particles. Element analysis for the porous nickel nanoparticles by energy dispersive x-ray spectroscopy (EDS) spectrum and mapping (FIGS. 8A-8D) indicates that nickel is the dominant element of the hollow nanoparticles and almost no oxidation is observed for those nanoparticles because the oxygen peak is invisible in the EDS spectrum.

The standard reduction potential of Ni²⁺/Ni ((−0.25 V versus SHE) is higher than that of Al³⁺/Al (−1.66 V versus SHE). Aluminum nanoparticles suspended in solution are attacked by Ni²⁺, being oxidized to Al³⁺, and Ni²⁺ is consequently reduced. The mechanism is also known as localized corrosion or pitting for macro-scale materials, which are responsible for collapsed metal structures due to interior material removal resulting from the corrosion. When the process is confined to the nanoscale, the process is illustrated in FIG. 1A. After the initial attack takes place on Al nanoparticles, the Al nanoparticles gradually hollow out with nickel deposited on the outer shell. It is believed that the replacement reaction starts at sites showing steps, point defects, or stacking faults with relatively high surface energy. During the process, the nickel continues nucleating on the Al template particle surface, forming a rough shell. The Al dissolution is confined to the spot where initial attack takes place, forming empty interiors. Besides providing electrons, Al nanoparticles also serve as supporting materials for nickel deposition and nucleation. Nickel metal continuously grows on the Al surface and eventually evolves into a shell structure which is self-supportive and robust around the Al template particles. The galvanic cell formed within each single nanoparticle is illustrated in FIG. 1B. Al is oxidized inside of the nanoparticle, producing three electrons. The electrons transfer to the surface of the nanoparticle due to the conductive nature of the metallic nanoparticle. On the particle surface, nickel is reduced, consuming two electrons for each nickel ion. The rates of these two reactions must be equal to maintain charge neutrality. The proposed mechanism fits well the current observations for the possible pathway of the galvanic replacement reaction.

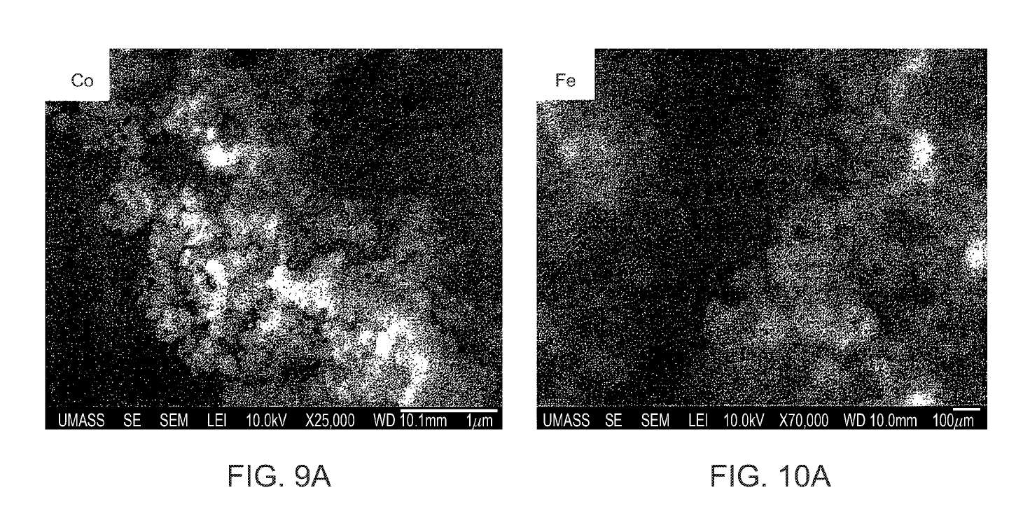

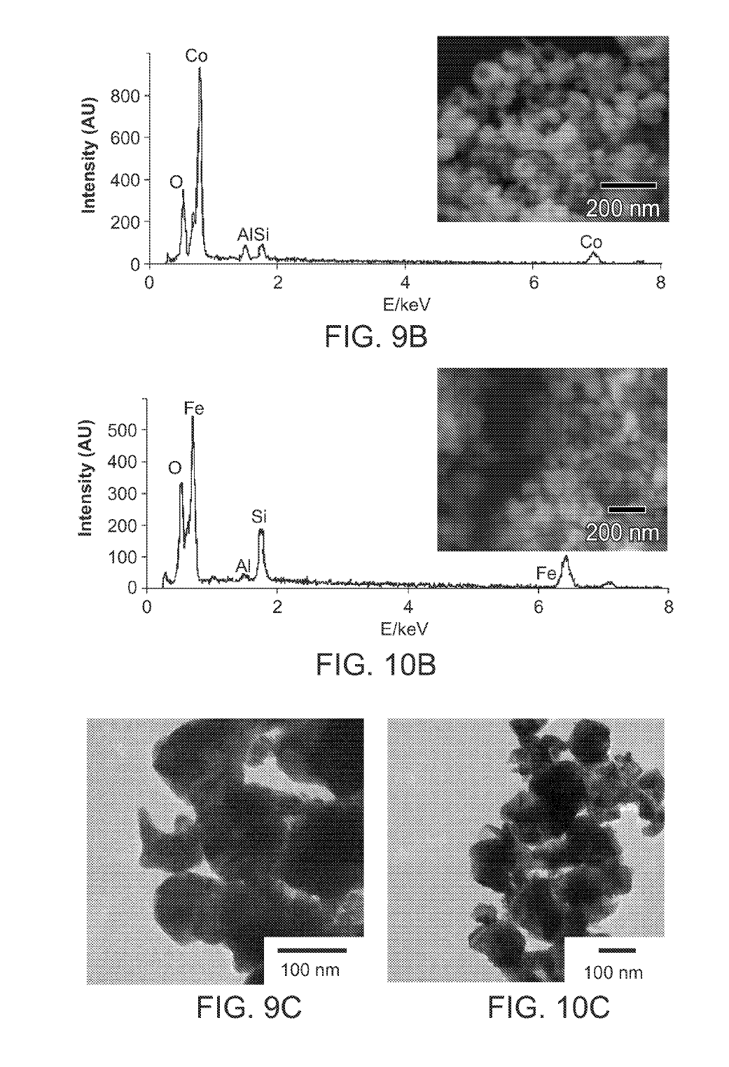

FIG. 9A is a SEM image of cobalt nano-shell particles formed on aluminum nano-particle template seeds.

FIG. 10A is a SEM image of iron nano-shell particles formed on aluminum nano-particle template seeds.

The porous cobalt and iron nanoparticles shown in FIGS. 9A and 10A were fabricated from the Al nanoparticle template when the nickel precursor was replaced by cobalt and iron precursors, respectively. As shown in the EDS analysis for the cobalt (FIG. 9B) and iron-based (FIG. 10B) nanoparticles, trace amounts of Al remain in the particles, even after extended reaction times. It is possible that there may be some alloy formation between Al and Co/Fe. This might be of special interest to catalysis applications since Raney metal is a mixture of aluminum and a second metal (such as nickel or cobalt). TEM images (shown in FIGS. 9C and 10C) for the Co and Fe particles were shown to indicate empty interior for both nanoparticles. From FIGS. 9B and 10B, oxygen peaks were present in the EDS spectra, leading to a conclusion that metal oxides were present in these samples. It is believed that the samples of Co and Fe porous nanoparticles tended to be oxidized more easily than nickel when exposed in air during testing of the samples (e.g., SEM/EDS sample preparation).

The synthesis of Co and Fe porous nanoparticles is an example of the breadth of porous nanomaterials that could be fabricated from the new template material with this simple one-pot synthesis process. Due to the large negative redox potential of aluminum, the galvanic replacement reaction on aluminum nanoparticle template can be used to synthesize many shell or porous structures from many other metals such as copper, silver, gold, etc. Those nanostructures can be used for applications that usually require large surface area/weight ratio.

The redox potential of Al³⁺/Al is −1.66 (VS SHE). Generally all types of metal ions with a higher redox potential can be reduced by Al nanoparticles, and thus the Al nanoparticle template can be used to form a nano-shell structure or porous nanoparticle structure with improved surface area for a variety of metal materials. The following table lists the several examples of metal/metal pairs and their redox potentials. The standard electrode potential for a variety of materials, which can be expressed in volts relative to the standard hydrogen electrode (volt vs. SHE), are well-known in the art, and are described in, for example, Atkins, Physical Chemistry, 6^{th} Ed. (1997).

TABLE 1

| Metal/Metal | Redox Potential |
|---|---|
| Pairs | (volt VS. SHE) |
| Zn²⁺/Zn | −0.76 |
| Ga³⁺/Ga | −0.53 |
| Cd³⁺/Cd | −0.40 |
| In³⁺/In | −0.34 |
| Co²⁺/Co | −0.28 |
| Ni²⁺/Ni | −0.25 |
| Pb²⁺/Pb | −0.13 |
| Sn²⁺/Sn | −0.13 |
| Fe³⁺/Fe | −0.036 |
| Cu²⁺/Cu | +0.34 |
| Ag⁺/Ag | +0.7996 |
| Pd²⁺/Pd | +0.915 |
| Pt²⁺/Pt | +1.188 |
| Au³⁺/Au | +1.52 |

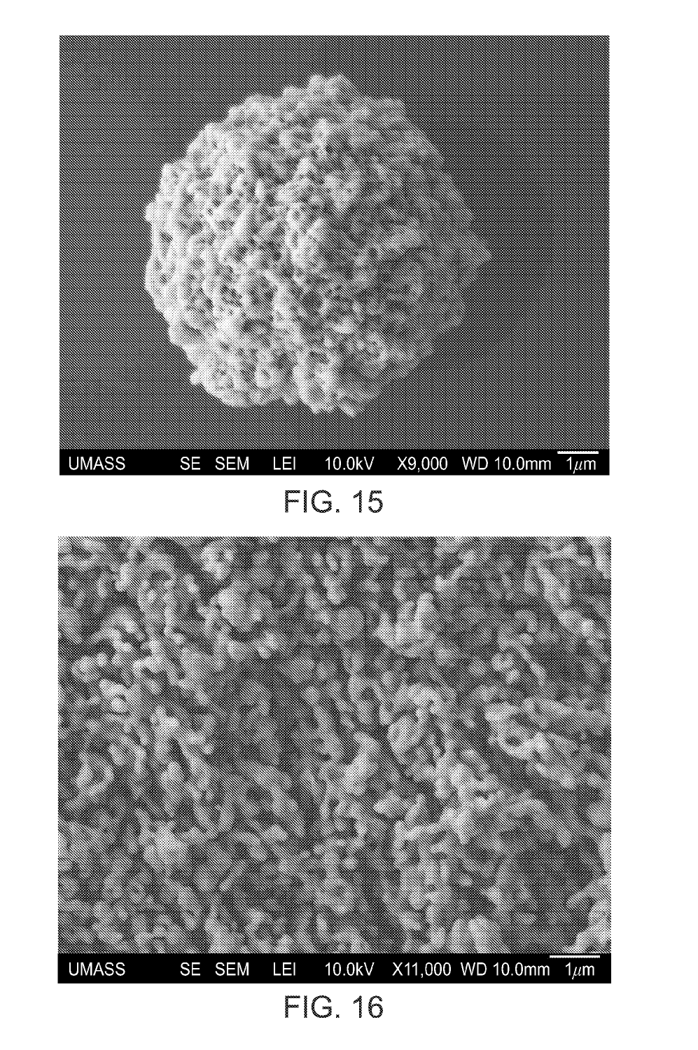

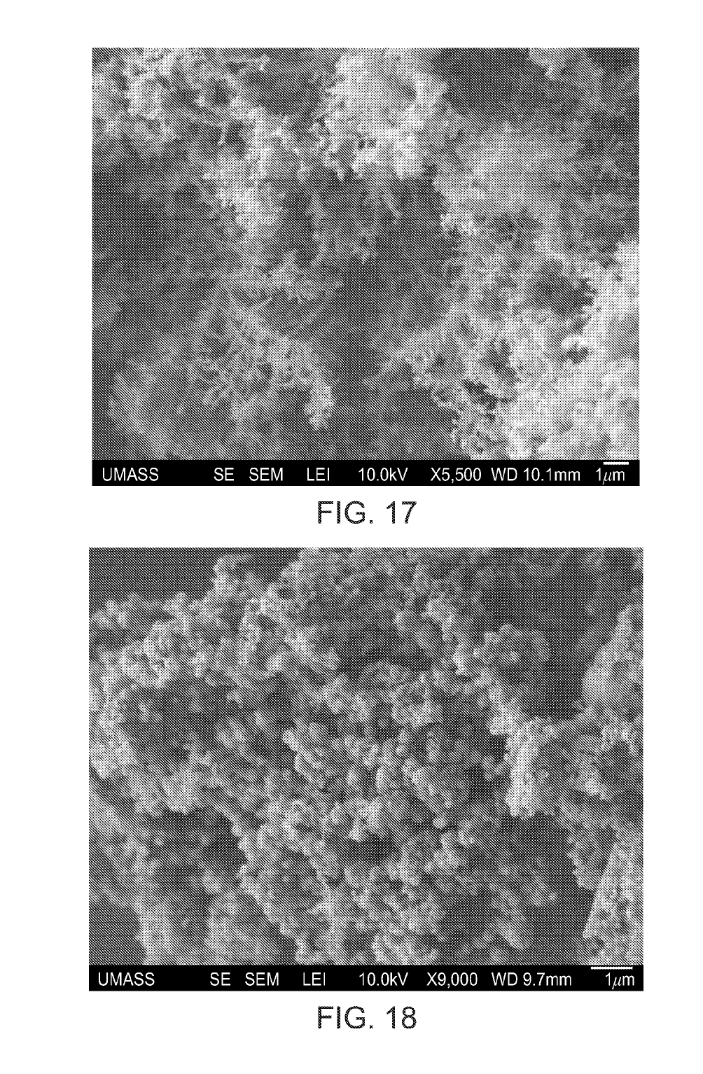

In addition to the Ni, Co and Fe nano-shell particles described above, a number of other nano-materials have been synthesized using the aluminum nano-particle templates described above. Examples include microsized, porous copper particles (FIG. 15), connected silver nanoparticles (FIG. 16), platinum-based materials (FIG. 17), and gold nano-shell particles (FIG. 18). In addition, combinations of various metals can be formed on the aluminum template material by the galvanic replacement reaction, such as bi-metallic layers.

In addition to aluminum, other active metal materials can be used as templates for the formation of metal nanostructures by the galvanic replacement reaction, including titanium, manganese, indium, chromium and zinc. In general, materials having a suitably low redox potential can be used as a template material for forming metal nanostructures. In one embodiment, the template materials have a redox potential less than about −0.30 volts relative to the standard hydrogen electrode. Metals having a higher redox potential than the template material can be reduced by the template materials to form nanostructures with a variety of metal materials. The template materials can have a spherical, cubic or wire geometry, for example, and can produce hollow spherical, cubic and tubular nanostructures, respectively.

Applications for the nanostructures of the present-invention include, without limitation:
Nanoheaters that can be used in advanced materials processing, nanomanufacturing, thermal manufacturing, microfluidics, MEMS/NEMS, Lab-on-a-Chip, and biomedical applications such as hyperthermia for killing cancer cells.
Nickel nano-shell particles can be used for hydrogen generation, fuel cells, and catalysts for other catalytic reactions and environmental remediation.
Automobile industries, which need catalytic materials, for example, catalysts in catalytic converters. Pd and/or Pt nanoshell structures, for example, can be used as catalysts for catalytic converters in automobiles.
Energy related companies that have focus in hydrogen generation and/or full cells. Currently the catalytic efficiency of the nickel nano-shell particles that have been fabricated in the diameter range of 100-200 nm are better than that of existing commercial nickel powders. If the size of the nickel nano-shells is lowered to 50 nm or below, significantly higher efficiency (10-100 times higher) are achieved. Accurate estimation can be obtained when the surface area of the smaller diameter nickel nano-shells are measured.
Electronics industry, which needs nano-heaters to lower the soldering melting points and prevent damage to adjacent components for electronics assembly and packaging.
Petroleum (fuel) and automobile industry, in which a lower ignition temperature is desired for fuel ignitions. In this case the nano-heater materials fabricated can be used as additives in the fuels.
Biomedical companies that are focused on lab-on-a-chip or for treatment of hyperthermia or other medical conditions.

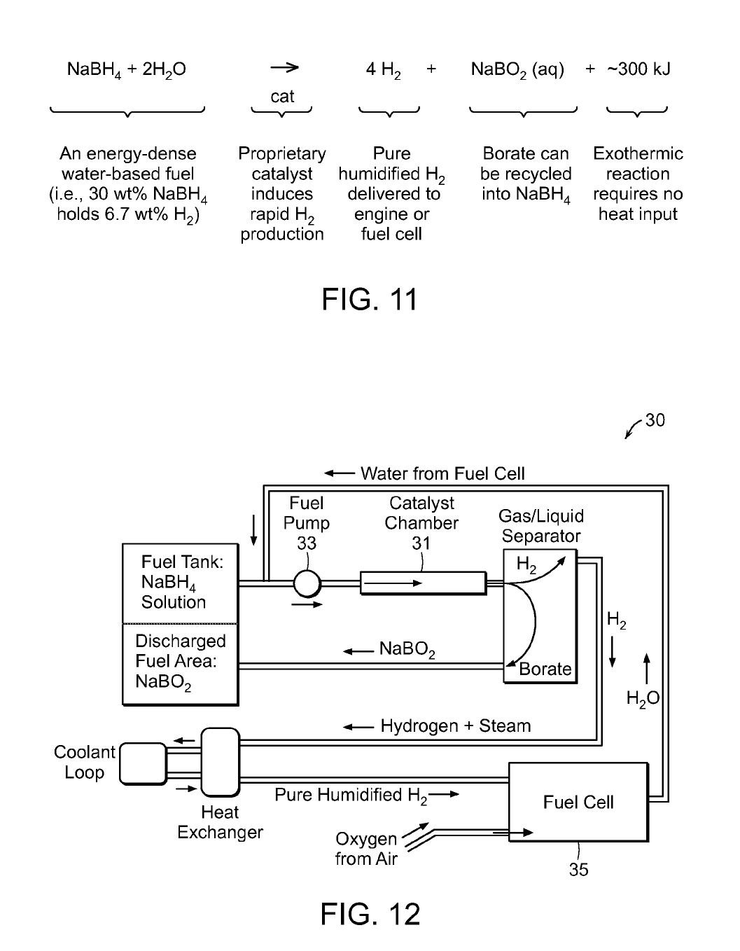

The porous nanoparticles of the invention can be used for a catalyst for sodium borohydride hydrolysis in hydrogen generation and fuel cells. The hydrolysis reaction for sodium borohydride (NaBH₄) is shown in FIG. 11. This hydrolysis reaction is advantageous in that the porous nanoparticle catalyst material induces rapid H₂ production, and the hydrogen is generated in a controllable, heat-releasing (exothermic) reaction. The fuel, which can be an energy-dense water-based fuel, is preferably a room-temperature, non-flammable liquid fuel that does not need to be maintained under pressure. Also, this reaction generally produces no side reactions or volatile by-products. In addition, the hydrogen that is generated through this reaction is generally high-purity (i.e., no carbon monoxide or sulfur), and is typically humidified, since the exothermic reaction produces some water vapor.

Hydrogen is a relatively expensive alternative energy source. Despite this, however, hydrogen remains on the list of appealing energy sources. This is mainly because it is a “zero-emission” fuel without any carbon dioxide production. Of course, this is only true when the energy used to make hydrogen is obtained from non carbon-based sources. Solid material based hydrogen sources, such as borohydride, are such a kind of hydrogen source.

Sodium borohydride, since its discovery in 1953, has been well-studied for its good reduction property and high hydrogen storage density. Its great potential as a hydrogen source is further bolstered by the fact that the high density hydrogen is stored in liquid (solution) or solid (salt) form, which significantly lowers the storage/transportation cost and avoids safety issue for high pressure hydrogen gas.

As demonstrated in the following reaction that the sodium borohydride hydrolysis reaction not only releases 4 hydrogen atoms per molecule, but also generates 4 extra hydrogen atom from water per molecule:

NaBH₄+2H₂O→NaBO₂+4H₂ ΔH=−217 kJ mol⁻¹

The high hydrogen storage density of sodium borohydride makes it suitable for a variety of applications such as hydrogen-on-demand systems, hydrogen based PEM fuel cell, direct borohydride fuel cells, etc.

As a direct hydrogen source, the advantages and disadvantages of sodium borohydride are listed in Table 2.

TABLE 2

| Advantages | Disadvantages |
|---|---|
| High capacity; | High cost of borohydride |
| Reaction products are | materials; |
| environmentally benign; | High cost of catalyst; |
| Easy to control; | By-product NaBO₂ removal; |
| Ambient temperature reaction; | Temperature control. |
| Low gas pressure; | |
| Fast kinetics; | |
| Solutions are nonflammable. | |

As shown in the table, there are several advantages including high hydrogen storage capacity, environmentally benign product, easily controlled process, ambient temperature reaction, fast kinetics and low operation pressure, and nonflammable reaction solutions. Temperature is preferably controlled to improve reaction rate. The use of material-based sodium borohydride hydrogen source is increasing with the increasing costs of other irreplaceable energy sources. These hydrogen sources have been used for fuel cell applications where portability, high capacity, no need to recharge, cleanness, high energy density. Transition metals including nickel and cobalt can be used as active catalysts for the hydrogen-generating reaction.

As previously discussed, the hollow metal nanoparticles of the present invention have much larger surface area compared to their solid counterpart. According to one embodiment of the invention, these hollow nanoparticles are utilized as catalyst materials for the sodium borohydride hydrolysis reaction and exhibit high activity, comparable to precious metal based catalysts.

In one example, nickel and cobalt hollow nanoparticles were fabricated by a galvanic replacement reaction on Al nanoparticles, as previously discussed. The samples were dried and stored in vacuum oven for a short time before usage. For long time storage, the nanoparticles were kept in a glove box (PLAS LABS, Model 818-GB) filled with ultra high purity Ar gas (Airgas East). Solid nickel nanoparticles (size: 50-100 nm, Nanolab, Inc.) and solid cobalt nanoparticles (size 20-60 nm, American Elements) were used for comparison. Sodium citrate, sodium hydroxide, and absolute ethanol were purchased from Fisher Scientific. Sodium borohydride (99 pure) was purchased from Acros Organics. Nanopure water (≧17.5 MΩ cm⁻¹, Barnstead Nanopure Water Purification System) was used to prepare solutions and clean samples.

The sodium borohydride hydrolysis reaction was performed in 0.10 g NaBH₄/5.0 ml 10% (wt) NaOH solution. NaOH solution was used to avoid spontaneous hydrolysis. The nanoparticle catalyst was in loose, unbound form. The catalyst generation and collection were performed on a home-made gas displacement apparatus. The generated hydrogen was collected and measured by an inverted 500 ml graduated cylinder through water displacement. Typically, 10 mg nanoparticle catalyst was put into a 50 ml flask filled with 5.0 ml sodium borohydride solution (corresponding to generation of a maximum 2.7 mmol (250 mL) H2 gas at R.T.P.). In detail, the flask was immersed in a water bath (AquaBath, Barnstead/Lab-Line) to obtain different temperatures. Once the solution reached thermal equilibrium with the water bath, the nanoparticle catalyst was added to the solution which was dispersed throughout the solution after slight ultrasonication. The reaction chamber was then sealed with a rubber stopper. A Teflon tube (with inner diameter of ⅛ inch) through the rubber stopper was used to transfer the evolved hydrogen from the flask to the graduated cylinder. For the first time use, the catalyst usually needed about an hour for activation, and then could be used to generate H₂ smoothly afterwards.

The nickel and cobalt hollow nanoparticles generally included an empty interior, and were in the size range from 100-200 nm and wall thickness 20-30 nm. The surface area for the nanoparticles was from 30 to 60 m²/gram according to BET measurements. This surface area is the equivalent to a surface area of 10-30 nm for solid nanopartices.

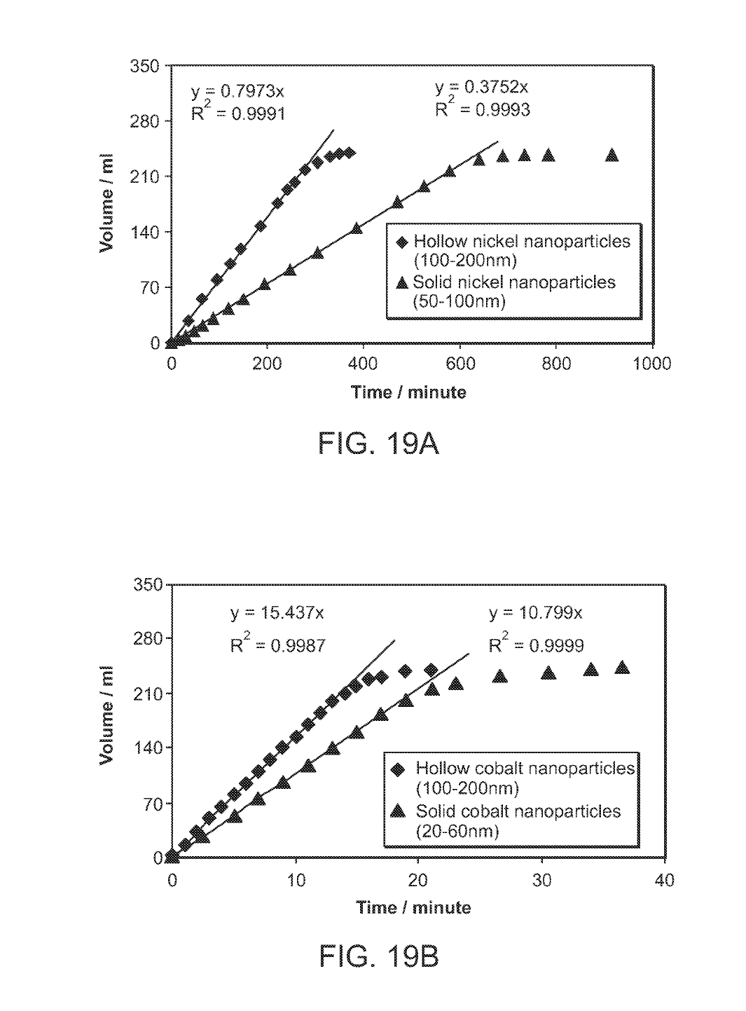

As shown in FIG. 19, the hydrolysis reaction is zero order reaction and the reaction rate is not related to the sodium borohydride concentration. To evaluate the catalytic property, the activity of the nickel and cobalt hollow nanoparticles is compared to that of commercially-available solid nickel and cobalt nanoparticles, with the results illustrated in FIG. 19. The zero order reaction remains a constant reaction rate for most of duration and then the rate decreases at the end of the reaction due to the depletion of NaBH₄ in the solution. As shown in FIG. 19, the catalytic activity on hollow nickel and cobalt nanoparticles is much higher than that from the commercial solid nickel and cobalt nanoparticles. The linear part is plotted to calculate catalytic activities and hollow nickel nanoparticles show about 2 fold catalytic activities over the solid nickel nanoparticles. It was also noted that it took longer time for the solid nickel nanoparticles to be activated than that of hollow nanoparticles, which usually takes an hour for the first time of use.

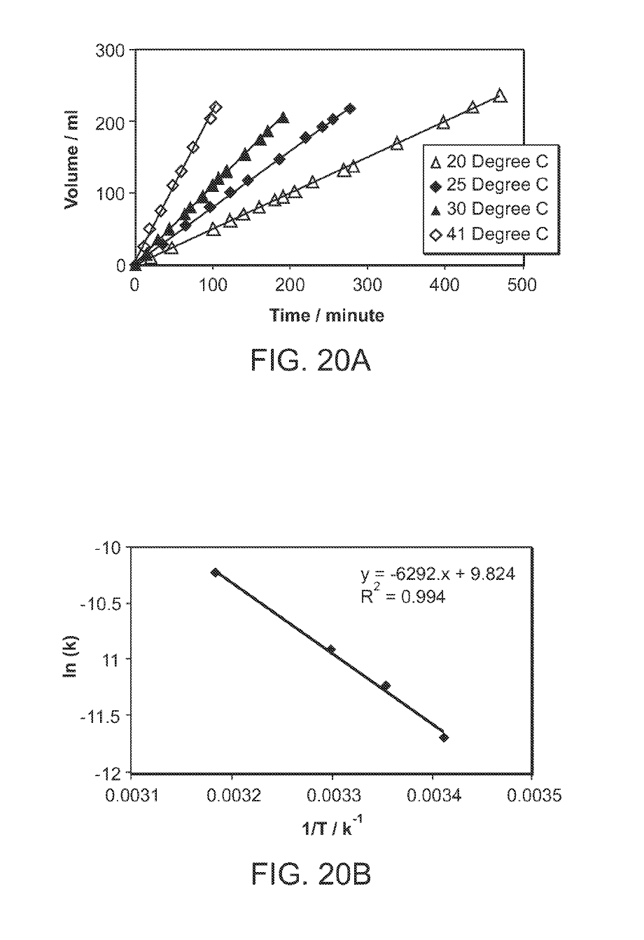

Beside catalyst quantity, temperature is a critical parameter in controlling the reaction rate for a zero order reaction. The temperature effect on the nickel hollow nanoparticles catalyst was analyzed as shown in FIG. 20A. From the result, the catalytic activities increase with increasing temperatures. The activities per gram of catalyst were calculated for different temperatures as shown in Table 3 and the R square values (close to 1) display good linear relationship.

TABLE 3
Activities at different temperatures
for the nickel hollow nanoparticles

Temperature (° C.)

| y = kx | 20.0 | 25.0 | 30.0 | 41.0 |
|---|---|---|---|---|
| Activity k | 50.1 | 79.7 | 109.4 | 216.4 |
| (ml/min/g) | | | | |
| R² | 0.9997 | 0.9991 | 0.9993 | 0.9956 |

From the activities at different temperatures, the Arrhenius plot was obtained from which the activation energy was calculated to be 52.3 kJ/mol (FIG. 20B). Table 4 shows the activation energy of the present hollow nickel nanoparticles compared to the activation energies for other materials, as reported in the literature. As shown in Table 4, the hollow nickel nanoparticle catalyst shows great ability in lowering the activation energy for the hydrolysis reaction. From the table, the activation energy decreased from 71 to 54 kJ/mol with decreasing nickel particle size from bulk material to nanoparticles. With the surface area further increasing by the hollow nanoparticles, the lowest activation energy of 52.3 kJ/mol was obtained.

TABLE 4

| | Activation Energy |
|---|---|
| Catalysts | (kJ/mol) |
| Bulk nickel | 71 |
| Ni powder (0.5-1 μm) | 63 |
| Raney Nickel | 63 |
| Nickel nanoclusters | 54 |
| Hollow Nickel Nanoparticles | 52 |
| Ru(0) Nanoclusters | 41 |
| Bulk cobalt | 75 |
| Co—B alloy | 69 |
| Hollow cobalt nanoparticle | 63 |

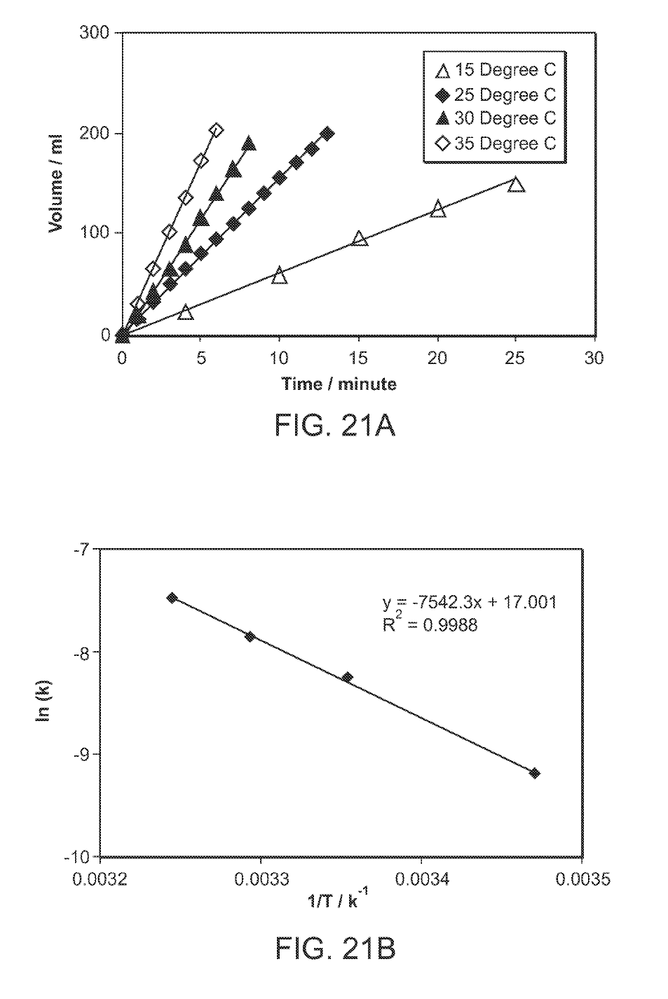

Based on previous reports in the literature, cobalt may be an even better catalyst candidate for the sodium borohydride hydrolysis reaction. Using the same galvanic reduction pathway, hollow cobalt nanoparticles were fabricated. The hollow cobalt nanoparticles were tested as the catalyst for the hydrolysis reaction at different temperatures, as shown in FIG. 21A. The hydrogen generation rates as shown in Table 4 are indeed very high compared to that achieved on nickel hollow nanoparticles.

TABLE 5
Activities at different temperatures
for the cobalt hollow nanoparticles

Temperature (° C.)

| y = kx | 15.0 | 25.0 | 30.5 | 35.0 |
|---|---|---|---|---|
| Activity k | 613.6 | 1554.2 | 2328.9 | 3382.4 |
| (ml/min/g) | | | | |
| R² | 0.9979 | 0.9993 | 0.9978 | 0.9991 |

Similarly, activation energy was calculated for the hollow cobalt nanoparticles from the Arrhenius plot as shown in FIG. 21B. The activation energy is 62.7 kJ/mole for the cobalt hollow nanoparticles, which is significantly smaller than that of bulk cobalt and cobalt alloy based catalysts (Table 4). The result is consistent to the observation in nickel catalysts that the activation energy lowers with decreasing catalyst particles sizes. This could be contributed by the fact that surface area is increasing with smaller particle size.

Table 6 summarizes the reported activities of various metal catalysts on the sodium borohydride hydrolysis reaction, and compares those results to the ones obtained in the present study (Table 6).

TABLE 6

| Catalysts | Rate (ml/min/g) |
|---|---|
| Ni powder (0.5-1 μm) | 19.5 |
| Co powder(1-2 μm) | 126.2 |
| Solid Nickel nanoparticles | 37.5 |
| (50-100 nm) | |
| Nickel Hollow nanoparticles | 79.7 |
| Cobalt hollow nanoparticles | 1500 |
| 10 wt. % PtRu—LiCoO2 | 1200 |
| 2 wt. % Pt—C | 200 |
| 5 wt. % Ru—C | 700 |
| 5 wt. % Ru on IRA-400 | 606 |
| Ruthenium | 1600 |

As shown in the table, the high catalytic activity obtained from cobalt hollow nanoparticles is comparable to the activities achieved on precious metal based catalysts previously reported. Therefore, the hollow nanoparticles provide a catalyst for sodium borohydride hydrolysis reaction for portable fuel cell from the hydrolysis reaction. They can also be used as catalyst for large scale hydrogen systems, such as hydrogen-on-demand systems, based on sodium borohydride hydrogen hydrolysis.

Aggregation of nanoparticles is one major reason for catalytic property decrease and deactivation. Especially for loose nanoparticles based catalysts, this is more obvious because in the liquid reaction media nanoparticles are easily in contact with each other. The nickel hollow nanoparticles based catalysts were tested for stability for multiple runs and from the repeat runs the catalyst remains relatively high activity. Although slight aggregation of the nanoparticles were observed after the first run, these aggregation can be broken after slight ultrasonication and washing with fresh 10% NaOH. However, slight activity decrease was observed for the cobalt nanopartice based catalysts after the first run and thereafter the catalyst is pretty stable for the hydrolysis reaction. The observation is consistent with observations of small fluctuation of activity for nanoparticle based catalysts as reported in the literature. Wide range size distribution of nanoparticles and their agglomeration during NaBH₄ hydrolysis are believed to be the major reasons for the fluctuation.

The performance of the porous nanoparticle catalyst can be improved using magnetic precipitation/separation techniques, for example, as well as by embedding the nanoparticles in a hydrogel material, as is discussed in further detail below.

In summary, the non-precious metal nanoporous particles have been measured as catalyst materials for the sodium borohydride hydrolysis reaction a useful hydrogen source. These hollow nanoparticle-based catalysts not only demonstrate great ability in improving catalytic activity and lowering activation energy, some of them (hollow cobalt nanoparticles) have also shown comparable catalytic activities to that achieved on the equivalent amount of precious metal based catalysts. Thus, these catalytic materials can be used as an alternative to the precious metal based catalyst materials for the sodium borohydride hydrolysis hydrogen generation technology. This significantly lowers the operational cost for the hydrogen technology, which makes the hydrogen source more appealing as a clean energy for fuel cells and hydrogen-on-demand systems.

As shown in FIG. 12, one application for the porous nanoparticle catalysts of the invention is as a catalyst for a hydrogen fuel cell. In the fuel cell power system 30 shown schematically in FIG. 12, the porous nanoparticles of the invention can be located in the catalyst chamber 31, preferably in solution. The fuel pump 33 feeds the fuel (NaBH₄) and water mixture to the catalyst chamber 31, where the porous nanoparticles catalyze the hydrolysis reaction described above to generate a humidified hydrogen gas stream for fuel cell 35. The borate (NaBO₂) by-product of the hydrolysis reaction can be recycled into sodium borohydride (NaBH₄) and re-used in the hydrolysis reaction.

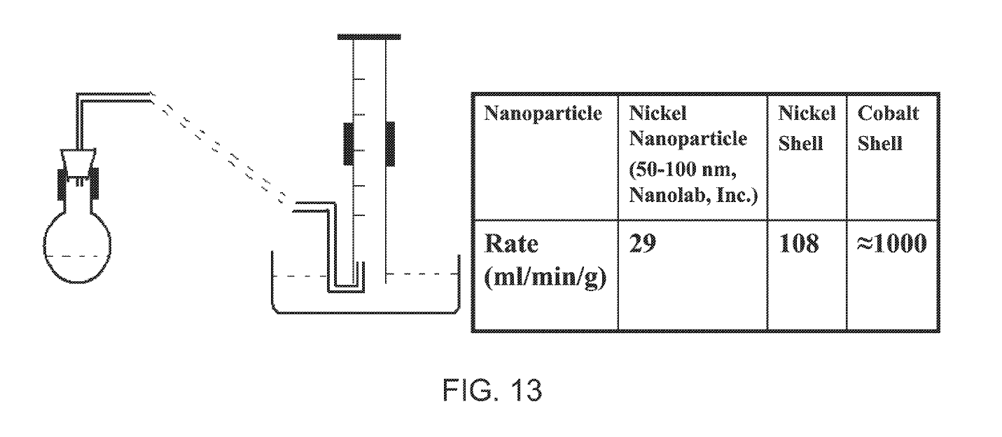

FIG. 13 illustrates the activity comparison for three different nanoparticle catalyst materials: a 50-100 nm nickel nanoparticle catalyst (from Nanolab, Inc. of Newton, Mass.), a porous nickel nano-shell catalyst, and a porous cobalt nano-shell catalyst. The experimental setup for hydrogen generation and collection is illustrated in FIG. 13. As can be seen from the table, the activity rate (ml/min/g) for the nickel nano-shell particles was 108, compared with 29 for the conventional solid nickel nanoparticles. The activity rate for the cobalt nano-shells was approximately 1000, which far exceeded both the nickel nanoparticles and the nickel nano-shells.

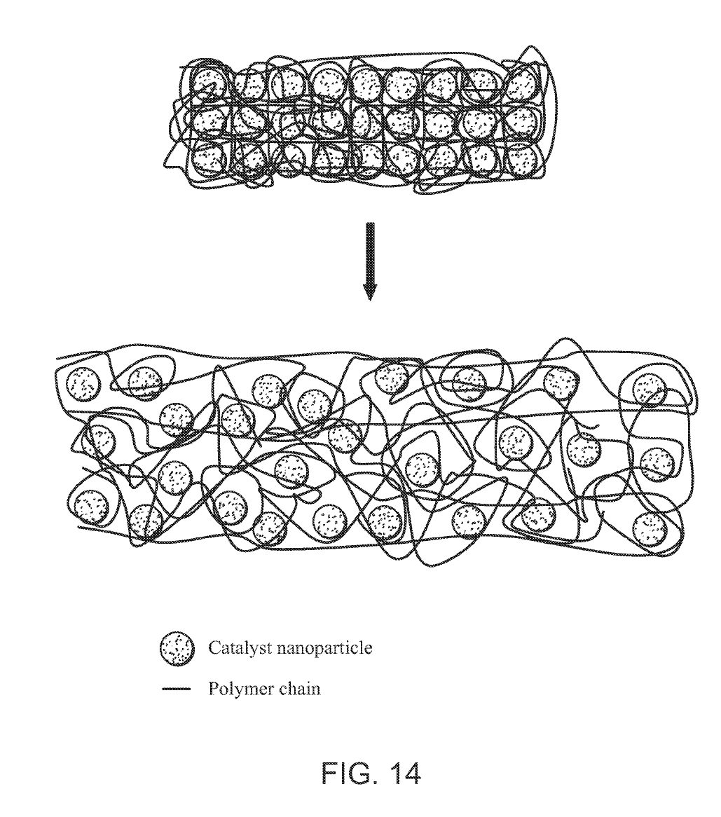

Turning now to FIG. 14, a nanoparticle catalyst material is shown embedded in a hydrogel material. In certain embodiments, a transparent hydrogel can be used to disperse nano-shell particles. This can facilitate the easy separation and recovery of nano-shell particles from the reaction solutions after the hydrolysis reaction. In one embodiment, a stock solution of poly(vinyl alcohol) (PVA) is dissolved in dimethyl sulfoxide (DMSO) and water mixed solvent at around 80° C. Nano-shell particles are then dispersed in the PVA stock solution and additional water is added. Ultrasonication can be used to help nano-shell particle dispersion. The PVA solution with nano-shell particles can be made into a film and then stored at about −20° C. for about 2 hours. The sample can then be placed in ambient temperature for about 8 hours and then washed with water.

The hydrogel with nano-shells can then be placed inside an aqueous solution, including for example a sodium borohydride aqueous solution, for a hydrogen generating reaction. After the reaction, the hydrogel with nano-shell particles can be taken out of the reaction solution and cleaned with water for subsequent use.

By embedding the nanoparticles in a dry hydrogel, the nanoparticles can be maintained in a small volume and protected by the hydrogel polymer coating. This makes the nanoparticles easy to store and transport. When in solution, the nanoparticle-embedded hydrogel swells, such that 90% or more of the volume is water. The fast specie exchange and diffusion between hydrogel and solution means that the nanoparticles become available for catalyzing reactions. By embedding the nanoparticles in a hydrogel, it becomes possible to minimize or avoid some of the known issues involving nanoparticle catalyst materials, including particle aggregation, recovery and oxidation issues. Hydrogels can be used as a nanoparticle catalyst carrier, and can be used, for example, as a pipeline film for a catalyst bed.

In yet another embodiment, the nanoshells can be coated onto inorganic support materials, such as microsized porous Al₂O₃ or Silica particles/powders. In one embodiment, Al seed nanoparticles can be coated onto these porous Al₂O₃ or silica particles, and then undergo the galvanic replacement reaction as discussed above to directly form metal nano-shell particles on these inorganic support materials. Alternatively, the metal (e.g., nickel or cobalt) nano-shells can be fabricated first and then dispersed onto inorganic support materials, such as Al₂O₃ or silica particles.

The nanoshells can be used for environmental remediation applications, such as using metal (e.g. cobalt) nanoshells to support a reaction for the degradation of azo dye (metal orange).

Turning now to another aspect of the invention, as applications in microelectronics, sensors, medical devices and diagnostics, and energy and information storage strive towards smaller, more integrated, and multi-material/multi-functionality designs, the challenge of joining dissimilar materials in small and non-flat regions represents a significant barrier. Typical joining methods, such as bulk heating or direct contact, cannot meet the challenges and demands of microscale joining. Previously, several novel processes have been developed to fabricate “nanoheaters”—i.e., a heterogeneous metallic system that generates a defined, localized exotherm when ignited. The size and discrete nature of these nanoheater structures makes them viable as a heat source that can be combined with a range of joining materials (e.g., solder, hot-melt and thermoset adhesives) to create a “self-heating” joining material. Such materials can be deposited in many ways onto the surfaces to be joined. Joining is then initiated when desired by a single point ignition (i.e., the nanoheater reaction can be designed to be self-propagating) or by selective exposure to the ignition source (e.g., laser, IR, induction heating).

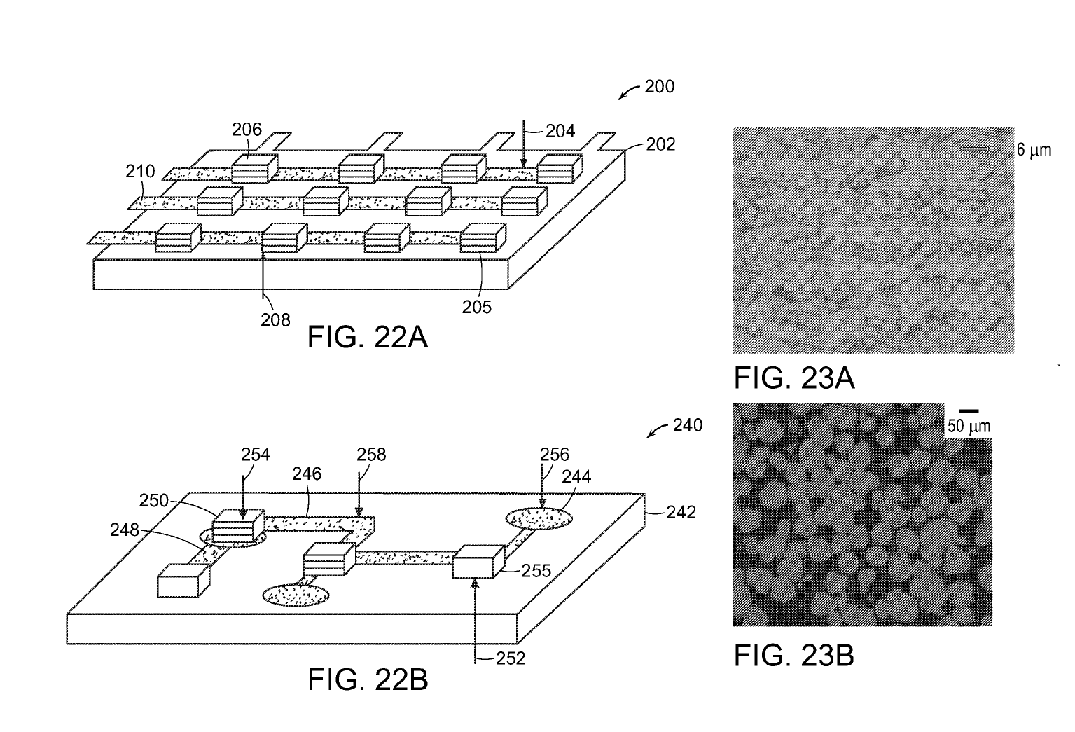

As shown in FIGS. 22A and 22B, for example, the concept of microscale joining on planar, flexible or curved substrates 202 using nanoheater structures is illustrated. A nanoheater array 200 can include nanoheater elements 206 formed on or joined with a substrate 202. The ordered array of heater elements 206 can utilize interconnects 210 to connect linear elements or to form a 2D matrix array. The elements can be connected to external ignition sources such as optical or radiation sources from above 204 or through 208 the substrate 202. The heating elements or other components can be attached using a joining material 205 such as a solder or adhesive as described herein. FIG. 22B illustrates a nanoheater system 240 which comprises one or a plurality of heater elements 250 which can be electrically or thermally connected by interconnects 246, 248 on substrate 242. An ignition source can be coupled using a heated junction 244 from thermal or radiation source 256 or can be remotely actuated 252 or directly 254, or using a thermal reservoir or ignition source 255. Different types of functional components, such as electronics or sensor elements, are provided. The components are joined using thin nanoheater layers (wherein the nanoheaters can be designed for different heat outputs), with non-contact (e.g., IR or laser) ignition. The nanoheater elements can be formed using hollow spheres, cubes or tubes, for example, made by the replacement reactions described herein.

To realize this novel microscale joining process, one should consider key fundamental processing-structure-property relationships of the nanoheater-joining-material composite, including material interactions in mixing and deposition that ultimately affect ignition, heat propagation, and joining effectiveness.

According to one embodiment, the present invention includes (1) the fabrication of composite nanoheater structures and joining materials, including the effect of mixing on proper distribution of heat output; (2) the deposition of the nanoheater-joining material composite onto flexible substrates; (3) the controlled, non-contact ignition of the nanoheaters; and (4) the joining of dissimilar materials and the joint functionality.

The present invention employs on joining at the microscale level where spatial and temporal control of temperature profiles is important in complex geometries and in heterogeneous devices.

Advantages of the present method of joining using nanoheater structures include: (1) Fewer processing steps and greater processability for curved (non-flat) substrates or flexible substrates (such as flexible electronics); (2) Suitability for 3D assembly with many interfaces or heterogeneous surfaces (e.g., micro-optical components embedded in sensitive systems, such as micro-lenses); (3) Limited heat exposure for heat-sensitive components (e.g., biological and polymer components integrated with ceramic or metal components); (4) Less materials usage; (5) More energy-efficiency (no bulk heating needed); (6) On-demand joining or repair in the field.

The present invention utilizes composite joining systems. Product applications include microscale devices such as Lab-On-Chips, micro-optical devices, advanced sensors, medical devices, and energy and information storage devices.

A number of methods for fabricating nanoheaters in various geometries have been developed. In addition, research has been undertaken to understand the implications of these geometries on conditions that might lead to unanticipated ignition. Three distinct fabrication methods for nanoheaters include core-shell nanopowders, bicomponent nanowires, and composite powder compacts.

Al—Ni core-shell nanopowders have been synthesized by a galvanic replacement reaction, as discussed previously herein. This galvanic method utilizes a novel aluminum (Al) nanoparticle template and facilitates facile synthesis of Al—Ni nanoparticles with controlled compositions. The result is a very high surface area to volume ratio, with a controlled ratio of Al and Ni in intimate contact. Different sizes of the template particles and different process times can be used to tune the heat output from these core-shell nanoheaters.

Ultrasonic Powder Consolidation (UPC) has been successfully used to compact Al and Ni powders and also Al and Ni nanoflakes (detailed methodology is described below). UPC provides a means for rapid consolidation of reactive powders into unreacted composites. Preliminary UPC experiments with Al and Ni powders conducted at Northeastern University Advanced Materials Processing Laboratory (AMPL) have shown promising results. FIG. 23A shows an equiaxed microstructure of aluminum ultrasonically consolidated from a fine aluminum powder (<7˜15 μm, 99.95%) at 573 K under a normal pressure of 150 MPa and duration of 1.0 s. This specimen was fully dense and withstood 180° bending indicating that metallurgical consolidation was indeed achieved. Although Ashby's consolidation map also predicts full densification for aluminum powders conventionally pressed at similar temperature and pressure, parallel experiments performed at 573 K and 200 MPa, but without ultrasonic agitation, never produced full density. FIG. 23B shows an Al—Ni consolidate produced at 150° C. for 1 s. The Al powders were fully deformed and metallurgically bonded leaving no porosity in the composite structure, yet no reaction between the Al and Ni took place, leaving the composite fully potent for ignition.

These nanoheaters can be fully characterized in terms of reaction temperatures, heat output/volume, and minimum ignition energy/powder concentration through experiments using high temperature DSC, in-situ XRD, and a modified Hartmann tube. These different nanoheater structures, while useful as model geometries in a parametric study of industrial safety (i.e., ignition characteristics), are also relevant because of their potential for industrial use. In particular, even as various electronics, sensors, medical, and information storage products that take advantage of rapid progress in miniaturization are envisioned, the ability to join dissimilar materials and complex geometries becomes the limiting factor. Thus, building on the successful creation of these nanoheater structures, fundamental scientific challenges can be addressed that can transform microscale joining.

There are various forms of existing welding/joining methods that are applicable to the joining of small objects, e.g., microelectronics components. They may be classified into two groups, fusion joining and solid-state joining. Diffusion bonding, deformation welding, friction joining and ultrasonic joining exemplify the solid-state joining processes. Due to their ability to produce metallurgical bonding at a relatively low joining temperature, these solid-state processes are advantageous in applications where excessive heating of the materials being joined is not tolerated.

However, except for thermocompression wedge bonding and ultrasonic joining, conventional solid-state joining processes are not applicable to the joining of very small parts and hence are generally not applicable to microelectronics packaging. Fusion joining processes that potentially apply to small-components are represented by electron-beam joining and laser joining in which focused application of high energy results in pinpoint melting and re-solidification of the materials being joined. These fusion processes, however, have their own limitations, particularly in applications where melting and/or excessive heating of the parts being joined is not allowed. Joining processes that involve melting of a filler metal may also be categorized as fusion joining processes. The latter processes are represented by brazing and soldering.

While the above methods all have different degrees of applicability to small-part joining, the microelectronics industry currently adopts only soldering and ultrasonic joining. Ultrasonic joining, when applied to microelectronics, takes the form of wire bonding in which interconnects are produced by ultrasonic joining of an integrated circuit to a printed circuit board with Al, Cu or Au wire. Ball bonding, another ultrasonic joining method used in microelectronics, does the same, except it involves partial melting of the bonding wire and thus is not strictly a solid-state process.

Soldering techniques have been very successful in the microelectronics assembly and MEMS integration. Solders are low-melting point metal alloys, and the most widely used solder is eutectic tin-lead (Sn/Pb, 63/37). However, due to the toxicity of lead, lead-free solders are being developed for electronic components assembly onto PCB (printed circuit board). In recent years, energy cost and demand have been increasingly high due to the energy shortage. In this sense, pursuit of less energy consuming or more energy efficient processes is much preferred. However, the current lead-free alternatives being used, e.g., tin/silver/copper (Sn/Ag/Cu, SAC), have melting points around 217° C. or higher (>30° C. higher than that of the Pb/Sn solder, 183° C.) and have to be processed (reflowed) at much higher temperatures than that of the Sn/Pb solders, which can negatively affect product reliability due to higher residual stresses in PCB assemblies. Thus, lower temperature processing using nano-solders or self-heating methods are strongly desired for microscale joining.

Similarly, in other lower temperature applications where a polymer adhesive (e.g., hot melt thermoplastic or cured thermoset) is desirable, the powder or liquid can be applied in small volumes (e.g., in powder or droplet form) for microscale joining. Most current methods, however, require bonding by external bulk heating, with some processes incorporating additives for UV curing or utilizing laser heating.

Joining using a filler material provides another approach to joining of small parts such as microelectronics components. However, due to the restriction that IC interconnects must be created at sufficiently low temperature, conventional brazing techniques that require furnace heating are not advantageous. Thus, use of a self-heating brazing material is essential. Reactive in-situ heating through exothermic solid material transformations has been well developed in macroscale, for example, in thermite welding of rail sections by ignition of iron oxide and Al powder mixtures, the Ni—Al system for thermal joining applications. The Ni—Al system is a pre-eminent system for joining since its intermetallic compounds (NiAl3, Ni2Al3, NiAl, Ni3Al) are accompanied by large exothermic formation enthalpies (−37.85 to −71.65 kJ/mol, room temperature). The Ni—Al system has been studied in solid-state combustion synthesis using pressed foil laminates (e.g, RNT foils), and ultrasonically welded or electroplated layers on metal substrates. However, the Ni—Al system has not been used in microscale joining, and more importantly, due to the brittle nature of foil laminates, it cannot be applied on flexible or curved substrates. There is therefore a significant need to develop new types of nanoheater structures (Al—Ni and others such as thermites) that satisfy such demand.

It is well-known that nano-sized materials exhibit novel electrical, optical, magnetic and mechanical properties. In the past two decades, techniques for nanomaterial synthesis and fabrication have progressed rapidly. However, joining and interconnect formation techniques have lagged behind and are becoming the bottleneck of circuit formation and electronics assembly. Two examples have shown promise in interconnect formation and joining at micro- and nanoscale: (1) annealing or sintering and (2) focused E-beam (FEB) or focused Ion-beam (FIB). Annealing is one way to lower contact resistance between components, which is similar as diffusion bonding or welding. However, the annealing temperature is normally high and this may damage certain electronic components. FEB/FIB-based joining has been used in the bonding of carbon nanotubes to substrates, nanotubes to nanotubes, and nanowires to nanowires. However, this technique suffers from slow processes and contamination. Even though facing various challenges, microscale joining has shown promise. More promisingly, the joining property may be increased by the enabling of nanotechnology. Thus, it is attractive to develop nanoheater structures as a new technique for the enabling of microscale joining.

One of the advantages of the nanoheater materials of the present invention is that the ratio of the two reactive metals—e.g., Al and Ni—can be controlled at the nanoscale, resulting in much finer local control of heat output. In addition, in this core-shell nanoparticle or nanoflake composite form, the nanoparticles can be mixed with the desired joining materials or deposited onto non-flat surfaces as desired to control the heat needed locally for joining.

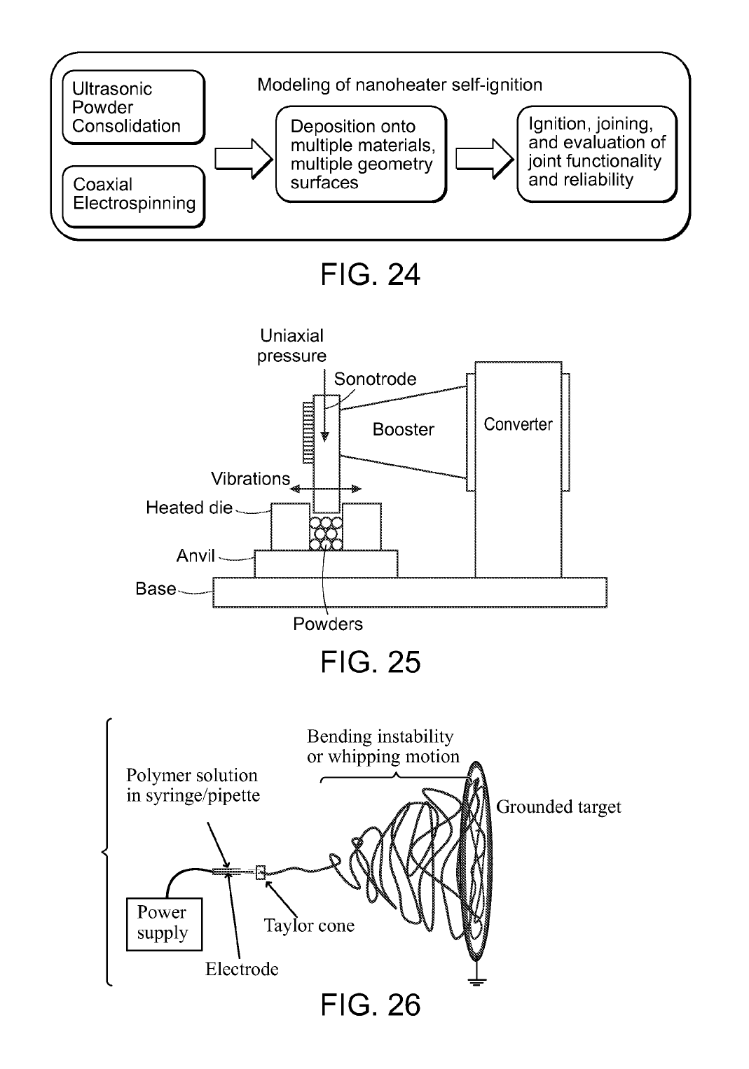

FIG. 24 is a flow chart illustrating one embodiment of a combined experimental and modeling approach for providing greater understanding of how to achieve effective material mixture and/or deposition of nanoheater materials without compromising the heat output of the nanoheaters, and how to control the subsequent ignition and reaction to join multiple material types and geometries. Studies integrating modeling of the self-ignition and systematic experiments on mixing, deposition, and ignition can be conducted to understand the capabilities and limits for nanoheater-based joining of functional parts on curved and/or flexible substrates. The model results are relevant throughout the process, since self-ignition needs to be prevented in the composite fabrication and deposition stages but is desired in the ignition/joining stage.

In one embodiment, nanoheaters of bimetallic and thermite energetic materials can be fabricated from powders and flakes of metals and oxides by an ultrasonic powder consolidation (UPC) process.

UPC is a form of ultrasonic welding (USW) in which particles, instead of sheet(s) or wire(s), are joined by the action of ultrasonic vibration (see FIG. 25). An exceptional feature of USW is its capability for both monometallic and bimetallic joints, as well as metal boding to polymers and ceramics such as glass, alumina, silicon, germanium and quartz. In particular, most metals and many of their alloys can be readily welded to themselves and to other metals. Thermoplastics can also be welded to other polymers (polyethylene, ABS, PVC, etc.). Other advantages of USW include its short welding time, usually less than a second, and limited pressure and heat, preventing damage to plastics and semiconductors, as well as residual stresses. Properly made ultrasonic bonds exhibit shear strength, hardness, high temperature behavior, and corrosion resistance comparable to the base material.

In addition, USW is not sensitive to surface oxide films, coatings and insulations, and usually requires no protective atmosphere. There is no need for special health and safety precautions, and no environmental hazards. Finally, the USW process has an excellent energy efficiency (80-90% of electrical power is delivered into the weld zone).

According to one aspect of the invention, at least three types of nanoheaters are fabricated using the UPC method. Process conditions required for full densification without initiating premature reaction of the metals will be studied. Experiments can be conducted to provide additional data for the self-ignition model. Al—Ni core-shell nanoparticles with variable compositions are fabricated using the galvanic replacement method described above. Commercially available Al and Ni nanoflakes less than 200 nm in thickness, produced by hammer milling, can also be used. Hammer-milled metal nanoflakes have many applications, e.g., circuit-board printing, conductive adhesives, and printing pigments, which indicates that they are suitable for producing a thin layer of flakes of desired elements on the substrate by a printing technique.

In one embodiment, 100-200 nm thick nanoflakes of Al and Ni are premixed in a low temperature-volatile liquid such as ethanol to produce well-mixed slurry. Using the slurry as ink, patterned coating of nanoflake mixture are printed on the substrate. The printing conditions can be optimized to lay the flakes flat on the substrate while allowing the liquid to vaporize. A similar process can be used for deposition of all three types of nanoheaters.

In one embodiment, bimetallic (Al—Ni) composite nanoheaters are fabricated on a substrate using two different types of metallic powders: Al—Ni core-shell nanopowders and Al and Ni nanoflakes. The bimetallic precursors are compacted by applying ultrasonic vibrations on them under normal pressures ranging from 50 to 200 MPa. Experiments with Al—Ni nanoflakes have shown that effective compaction can be achieved with full metallurgical bonding of Al flakes. Unlike high-temperature sintering of nanoparticles where undesirable particulate coalescence occurs, burnout is not a problem in UPC. Ultrasonically compacted nanoflake precursors can have uniform bimetallic flake distributions and full density.

According to yet another embodiment, thermite (Al—Fe oxide, Al—Cu oxide, Al—Ni oxide) nanoheaters are fabricated on a substrate using Al nanoflakes and metal oxide powders. Thermite precursors are prepared on the substrate by slurry coating. Slurries consisting of Al nanoflake and hematite (Fe₂O₃) or NiO powder mixture can be used. Initial experiments for Al-hematite thermite nanoheaters can use pieces of floppy disks as the hematite-coated substrate.

According to yet another embodiment, hybrid bimetallic-thermite (Al—Ni—Fe oxide, Al—Ni—Ni oxide) nanoheaters of Al—Ni—Fe oxide and Al—Ni—Ni oxide are fabricated on a substrate using Al and Ni nanoflakes, Al—Ni core shell nanopowders and hematite (Fe₂O₃) and NiO powders. Precursors are prepared with mixing ratios of Al, Ni and Fe₂O₃ or NiO that allow both the bimetallic and thermite reactions.

In addition to UPC, another approach to fabricating nanoheater composites is electrospinning, with polymers as the desired joining material. The primary attraction of electrospinning for this application is the ability to mix and immediately deposit onto the target substrate at relatively low temperatures. The process has been demonstrated for a broad range of polymer solutions and generates a thin and relatively uniform fibrous coating.

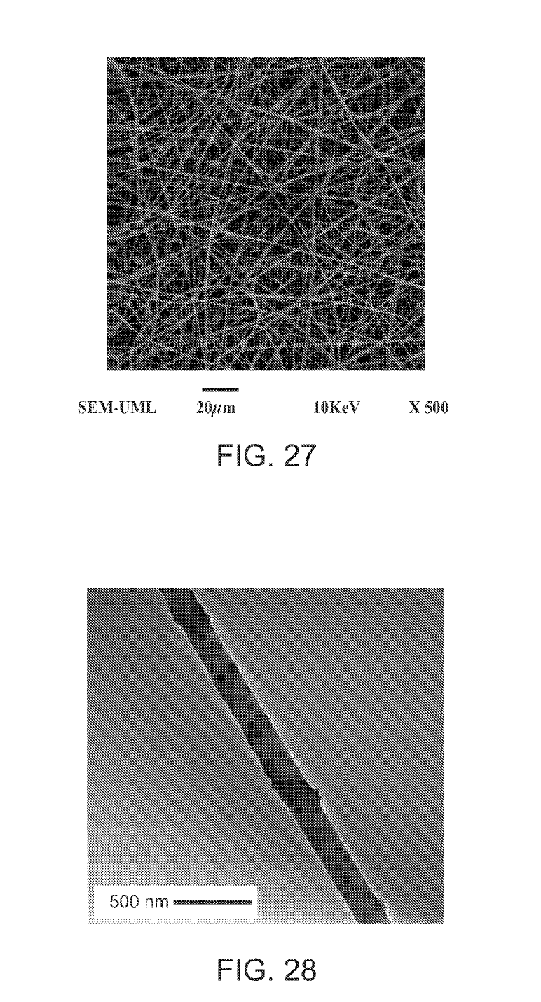

Electrospinning is a process for fabricating nanofibers and nanofiber mats from a broad range of polymer solutions (and to a lesser extent, polymer melts). FIG. 26 shows a schematic of a electrospinning system. A pendant droplet, also known as a Taylor cone, forms at the tip of the pipette or syringe. On applying a high voltage to the polymer solution or melt, the charged droplet elongates towards the target, ultimately forming a jet when the applied electric field exceeds the surface tension forces. As the jet of solution travels towards the target, it undergoes a bending instability or whipping motion, thereby reducing the jet diameter. In solution electrospinning, the solvent continues to evaporate, increasing the solids content and further reducing the fiber diameter. For melt electrospinning, the polymer must initially be heated to reduce the viscosity to achieve flow, and the cooling of the jet results in formation of the solid fibers. In both cases, a nonwoven semi-dry fiber mat is formed on the target. FIG. 27 presents an SEM image of a typical random-orientation, continuous-fiber mat resulting from solution electrospinning onto a flat target. Coaxial electrospinning or co-electrospinning represents a variation in which the ratio and position of the multiple materials comprising the final fiber is controlled. Coaxial electrospinning relies on a coaxial syringe design to separate the flows of two or more materials, while co-electrospinning relies on a more self-assembly approach where precipitated droplets within the solution are stretched by the surrounding fluid.

Various process parameters can effect fiber formation, including solution conductivity, concentration, molecular weight, viscosity, electric field strength, feed rate, and environmental conditions (temperature and humidity). Depending on the material and process conditions, morphologies ranging from fibers to beads to a thin film can be generated. For example, beads can form when the effect of surface tension dominates the combined effect of electrostatic repulsive charges and the viscoelastic forces that typically lead to fibers. If droplets are sufficient in this joining application, the electrospraying process, which uses a similar setup but lower solution viscosities and applied electric fields, can be used to deposit the nanoheater-joining material onto substrates.

A preferred method involves directly mixing nanoparticles into the solution prior to electrospinning. FIG. 28 shows a TEM image of a composite fiber electrospun from a mixture of poly(ethylene oxide) (PEO) and phosphotungstic acid (PTA) nanoparticles (used to enhance the microscopy). The nanoparticles often aggregate and reside towards the fiber surface. To distribute the nanoheater particles more centrally within the adhesive material, a coaxial setup can be used. The nanoparticles are dispersed in a solvent that is pumped through the center portion of the syringe, while the adhesive polymer is pumped through the outer ring. The adhesive polymer can be, for example, a one or two-part thermoset that requires heat to initiate the curing or a melted thermoplastic. The solvent evaporates, leaving a composite fiber or beaded mat on the surfaces to be joined. Because of the small fiber diameter, and the direct deposition, electrospinning is capable of covering curved surfaces (including multiple curvatures). To complete the joining, the second component is be placed on the coated surface and the nanoheaters are ignited, resulting in remelting and adhesion of the thermoplastic adhesive or curing and adhesion of the thermoset adhesive.

A few different polymer adhesive materials can be studied. For example, as a thermoset example, a low viscosity (˜50-500 cP) epoxy adhesive (e.g., 3M™Scotch-Weld™Epoxy Adhesive/Coating 2290, a 40-80 cP solution meant for spray coating). This epoxy has a recommended B-stage cure ranging from 93° C. for 45 minutes to 149° C. for 10 minutes. Final cure typically occurs at 177° C. for 30-60 minutes. The ignition and curing will be discussed below.

In another embodiment, melt electrospinning using lower viscosity thermoplastic (“hot-melt”) adhesives (e.g., Polypropylene or Polyethylene terephthalate) can be employed. This embodiment can require adding a heating element to the electrospinning setup. Preheating of the polymer and a hot air-integrated delivery system can be used.

According to certain embodiments, nanoheater-based joining of functional parts on curved and/or flexible substrates can use the following fabrication procedures, summarized in Table 7.

TABLE 7

| Procedure A | | Procedure B | |
|---|---|---|---|
| 1. | Fabrication of a thin layer | 1. | Fabrication of a thin layer |
| | of precursor on the substrate | | of precursor on the substrate |
| | surface | | surface |
| 2. | Addition of solder or filler | | |
| | material on the precursor layer | | |
| 3. | Ultrasonic consolidation of | 2. | Ultrasonic consolidation of |
| | solder and nanoheater composite | | the precursor into nanoheater |
| | layers | | layer |
| 4. | Placement of functional part | 3. | Placement of functional part |
| | on the composite layer | | on the precursor layer |
| 5. | Ignition of nanoheater for | 4. | Ignition of nanoheater for |
| | reflow of solder and joining | | thermal joining of part |
| | of part | | |

Procedure A applies to the joining of heat-sensitive functional parts to the substrate, while Procedure B, which uses the nanoheater as the self-heating brazing material, is considered for functional parts, e.g., ceramic parts, which can tolerate heating.

Laser and microwave heating can be employed as means for igniting or curing the nanoheater. Laser heating can be used for joining configurations and materials that require pinpoint ignition of the nanoheater. An example of a joining configuration that requires such pinpoint ignition is one in which a heat sensitive part, e.g., a microelectronics component, is joined on a transparent substrate (e.g., polyester or polyimide). In either Procedure A or B, laser energy can be directed to the nanoheater through the transparent substrate for pinpoint ignition and part joining. Microwave heating can be utilized, for example, in cases that need more uniform heating. Infrared heating under flowing argon atmosphere is another means for joining if rapid bonding is preferred. In addition to the ignition by external means, self-ignition at a low, controlled ambient temperature can be utilized with a high interfacial-area bimetallic nanoheater. Testing of the self-ignition mode is justified based on literature data of Al—Ni multi-nanobilayer foil which may self-ignite at temperature as low as 220° C.

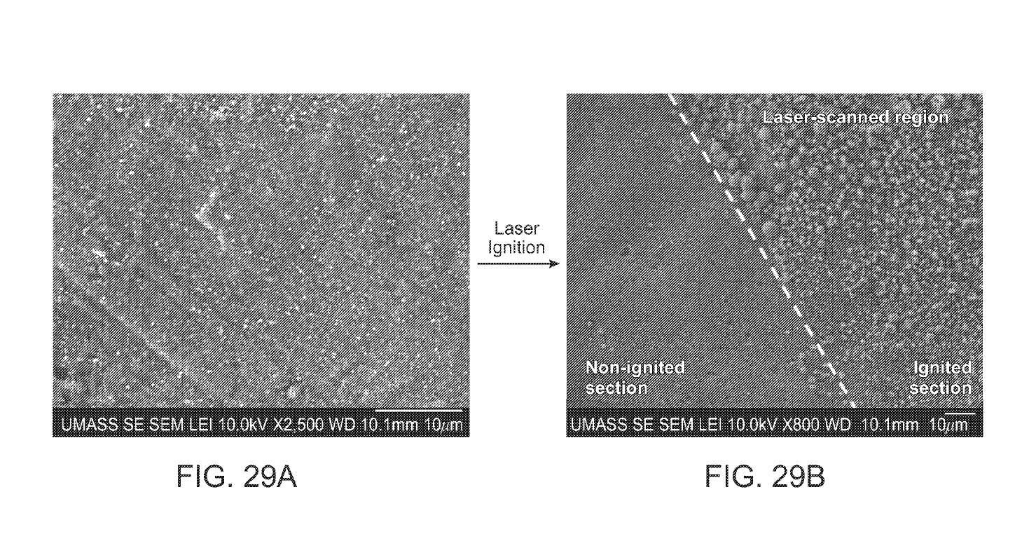

UPC consolidated Al—Ni core-skill nanoparticles have been successfully ignited by a femto-second laser. In order to test the feasibility of the nanoheater structures using laser ignition, the following experiments have been conducted. First, the UPC consolidated Al—Ni nanoparticles were placed on a silicon substrate and irradiated in air by a femtosecond laser with 800 nm wavelength, 100 fs pulse, and 1 kHz frequency (about 800 mW) from an amplified Ti:sapphire laser. The samples were placed on a motorized 2-D stage with a scanning speed of about 100 um/s. The femtosecond laser went through a lens with focus length of about 20 cm, and the distance between lens and samples was about 18 cm. FIG. 29A shows the SEM image of a piece of UPC consolidated Al—Ni nanoparticle sample before laser irradiation. It can be seen that the surface of the sample was relatively smooth. However, after laser scanning and irradiation, the sample was ignited and Al—Ni alloys formed on the surface (FIG. 29B). This indicates that lasers can be used to remotely ignite nanoheater structures in a controlled and precise manner.

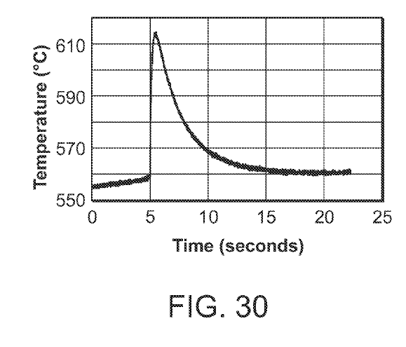

A consolidated Al—Ni sample was also ignited by a torch and the temperature was monitored by a thermocouple. FIG. 30 shows the ignition of a sample that was consolidated at 112° C. under 90 MPa pressure. As can be seen from FIG. 30, there is a quick temperature rise around 590° C. upon sample ignition, indicating the specimen ignited significantly below the temperatures at which liquid formation is expected, i.e., the melting temperature of pure Al (660° C.) and the eutectic temperature between Al and Al₃Ni (640° C.). Such a behavior can occur for specimens with a very high Al—Ni interfacial area per unit volume in which the solid state reaction Al(S)+Ni(S)->Al₃Ni(S) may cause self heating even in the absence of liquid.

Besides the mechanical aspects of joining, there are other relevant properties such as electrical resistance and optical transmission loss that need to be considered depending on the application.

The substrate materials (seen in FIGS. 22A and 22B) that can be utilized include, without limitation, flexible metalized polymers (e.g., silver on polyester), flexible polymers with microchannels (e.g., soft lithography using PDMS), and flexible metal wires/ribbons (e.g., electronic wire bonding materials). The components to be joined include, without limitation, silicon chips (with metal layers), optical fibers (polymer coated), and metal parts (e.g., for radiopaque markers). The curvatures can range from 0.01 mm⁻¹ (macroscale bends on human arm scale) to 0.1 mm⁻¹ (mesoscale bends on human finger scale) to 0.5 mm⁻¹ (near microscale bends on large blood vessel scale). The ignition method can be, for example, bulk ignition (e.g., microwave or induction), or pinpoint ignition (e.g., laser).

A number of applications can include, for example, the integration of optoelectronics in 3D packaging can be enabled by the microscale joining with nanoheaters.

In another embodiment, a self-ignition mode for Al—Ni bimetallic nanoheaters with a very high Al—Ni interfacial area is used. In both self-ignition and external heating and ignition, formation of liquid is considered to trigger the subsequent rapid reaction of aluminum and nickel to form a compound. Self-ignition, however, differs from external heating and ignition in that in the former a solid-state reaction Al(s)+Ni(s)→Compound(s) initially provides the heat for the nanoheater to heat up by itself to the liquid forming temperature, whereas in the latter the liquid forming temperature is reached because of the external heat supply. An x-ray diffraction measurement has shown that the initial solid-state reaction is 3Al(s)+Ni(s)→Al₃Ni(s), which produces particles of Al₃Ni at all places of the Al—Ni interface in the nanoheater. As the reaction rate is considered to depend strongly on temperature, a critical initial temperature exists above which the rate of heat generation by the reaction exceeds the rate at which heat is lost from the nanoheater. The initial temperature thus depends on the Al—Ni interfacial area as well and the size and shape of the nanoheater, and can be substantially below the equilibrium temperature for nanoheaters with a very high Al—Ni interfacial area. Al—Ni multi-nanobilayer foil may self-ignite when heated to 200° C. or above.

The basic heat balance equation that is employed in the model is

$$ρ C \frac{d T}{d t} = Δ H ρ \frac{d x}{d t} - Σ \qquad ( 1 )$$

where ρ is the density, C is the heat capacity, ΔH is the enthalpy of reaction, x is the volume fraction of the compound formed, and Σ [symbol] is the heat losses due to conduction, convection and radiation. An important aspect for successful modeling is the way the reaction rate dx/dt is addressed in Eq. (1). The reaction rate dx/dt in Eq. (1) can be calculated from the Avrami-type expression for x(t) developed in our current research that explicitly addresses both the nucleation and growth rates of the compound:

x(t)=π·S_{Al/Ni}⁰∫ₜ_{₀}^{t}Iᵢexp{−π∫ₜ_{₀}^{t}^{ᵢ}Iⱼ[∫ₜ_{ⱼ}^{t}^{ᵢ}Gᵢdτ]²dtⱼ}·W[∫ₜ_{ᵢ}^{t}Gᵢdτ]²dtᵢ (2)

where t₀ is the initial time, Iᵢ is the rate of nucleation on the A/B interface (in m⁻²·s⁻¹) and Gᵢ is the lateral growth rate (in m·s⁻¹), both at time tᵢ, S_{Al/Ni}⁰ is the Al/Ni interfacial area per unit volume at t₀, S_{Al/Ni}^{t}^{ᵢ} is the Al/Ni interfacial area per unit volume at tᵢ, and W is the thickness of the compound particles. Substitution of the instantaneous reaction rate Δx/Δt in Eq. (1) yields the temperature for the next computation step.

In employing Eq. (2) in our model, assume that the unreacted part of the Al—Ni interface maintains a “metastable local equilibrium” such that the interfacial concentrations are determined by the common tangent on the free energy curves of Al(Ni) and Ni(Al) solid solutions. Under such conditions, the driving force for the precipitation of an intermetallic compound is reduced from that of the case where the interface maintains the pure states of Al and Ni. Nonetheless, the reduced driving force has a fixed value for a given temperature. Thus, the nucleation and growth rates, Iᵢ and Gᵢ, can be regarded to depend only on temperature. To determine I(T) and G(T), bimetallic coupon specimens of Al and Ni, fabricated by plating and sputtering techniques, can be isothermally heat treated at different temperatures between 200-550° C. for different durations. The heat-treated specimens can then be submerged in an aqueous NaOH solution to dissolve only the aluminum layer and reveal the Al—Ni intermetallic particles that form during the heat treatment. I(T) can be determined from I(T)=∂N_{T}(t)/∂t where N_{T}(t) (in m⁻²) is the number of intermetallic particles counted on the interface of a specimen heat treated at T for time t. G(T) can then be calculated from the area fraction f_{T}(t) of particles (which can be determined with image analysis software) using the isothermal Avrami equation f_{T}(t)=1−exp[−π·I(T)G(T)t³/3]. The thickness of the particles, W, is comparable to the diffusion distance at the growing edge, D/G, where D is the interdiffisivity.

The present nanoheater-based joining techniques provide an enabling tool for electronics assembly and packaging. The composite materials fabricated with nanoheaters and the structure-processing-property relationships obtained from this research can also be applied to other fields such as medical devices, MEMS/NEMS, and sensors.

Nanoshell particles can be dispersed into Nafion polymer and coat them onto carbon glass electrode for biomolecular detection or sensing. The porous nanoparticles were mixed with Nafion which was dispersed in ethanol. The mixture was then coated onto the surface of a glassy carbon electrode. After drying, a polymer film embedded with porous nanparticles was formed. This modified electrode was then used as a working electrode in a three electrode setup to measure biomolecules in a buffer solution. During this process, the porous nanoparticles serve as an electro-catalyst for the biomolecular oxidation/reduction process.

In other embodiments, these nano-shell particles can be manufactured with magnetic properties suitable for use as an MRI contrast agent. Alternatively, therapeutic agents can be inserted into the hollow cavity in the nano-shell for use as drug delivery containers.

While the invention has been described in connection with specific methods and apparatus, those skilled in the art will recognize other equivalents to the specific embodiments herein. It is to be understood that the description is by way of example and not as a limitation to the scope of the invention and these equivalents are intended to be encompassed by the claims set forth below.

1. A method of making a nanostructure using a metal template material, comprising:
forming a layer on a surface of the metal template material by a replacement reaction, the metal template material having a redox potential that is less than −0.30 volts relative to a standard hydrogen electrode.

2. The method of claim 1, further comprising forming a layer on a surface of the metal template material by a galvanic replacement reaction.

3. The method of claim 1, further comprising forming a layer on a surface of the metal template material by a replacement reaction in an inert atmosphere.

4. The method of claim 1, further comprising forming a metal layer on a surface of the metal template material.

5. The method of claim 4, wherein the metal layer comprises one or more non-noble metals.

6. The method of claim 4, wherein the metal layer comprises nickel.

7. The method of claim 4, wherein the metal layer comprises cobalt.

8. The method of claim 4, wherein the metal layer comprises iron.

9. The method of claim 4, wherein the metal layer comprises at least one of zinc, gallium, cadmium, indium, lead, copper, tin, palladium, silver, platinum and gold.

10. The method of claim 4, wherein the metal layer comprises at least two different metals.

11. The method of claim 1, further comprising:
removing a portion of the metal template material by the replacement reaction to produce a nano-shell particle having a hollow interior portion.

12. The method of claim 11, wherein the nano-shell particle has a porous outer layer.

13. The method of claim 1, further comprising:
quenching the replacement reaction to control the ratio of material formed as the layer to the material comprising the metal template material.

14. The method of claim 1, further comprising:
sacrificing the metal template material by the replacement reaction to form the layer.

15. The method of claim 1, further comprising:
replacing a portion of the metal template material with a second material forming the layer to provide a hetero-nanostructure.

16. The method of claim 1, wherein the nanostructure has an outer dimension that is about 200 nm or less.

17. The method of claim 1, wherein the nanostructure has an outer dimension that is between about 100 and 200 nm.

18. The method of claim 1, wherein the nanostructure has a generally spherical shape.

19. The method of claim 1, wherein the nanostructure has a generally cubic shape.

20. The method of claim 1, wherein the nanostructure has a generally tubular shape.

21. The method of claim 1, wherein the metal template material comprises aluminum.

22. The method of claim 1, wherein the metal template material comprises titanium.

23. The method of claim 1, wherein the metal template material comprises at least one of manganese, zinc, chromium and indium.

24. The method of claim 1, further comprising:
placing the metal template material into a solution containing one or more metal precursors, and forming a metal layer on a surface of the metal template material by a replacement reaction in an inert atmosphere.

25. The method of claim 24, wherein the metal template material is placed into a solution of NiSO₄, NH₄Cl and sodium citrate to form a nickel nanostructure.

26. The method of claim 24, wherein the metal template material is placed into a solution containing cobalt (II) chloride hexahydrate to form a cobalt nanostructure.

27. The method of claim 24, wherein the metal template material is placed into a solution containing ferrous sulfate heptahydrate to form an iron nanostructure.

28. The method of claim 1 further comprising forming a catalyst.

29. The method of claim 1 further comprising forming a heating element.

30-47. (canceled)

48. A nanostructure, comprising:
a metal layer formed on a surface of an aluminum template material by a replacement reaction.

49. The nanostructure of claim 48, wherein the nanostructure has an outer dimension that is about 200 nm or less.

50. The nanostructure of claim 48, wherein the nanostructure has an outer dimension that is between about 100 and 200 nm.

51. The nanostructure of claim 48, further comprising:
a hollow void portion in the interior of the nanostructure.

52. The nanostructure of claim 48, further comprising:
a porous outer surface portion of the nanostructure.

53. The nanostructure of claim 48, wherein the nanostructure has a generally spherical shape.

54. The nanostructure of claim 48, wherein the nanostructure has a generally cubic shape.

55. The nanostructure of claim 48, wherein the nanostructure has a generally tubular shape.

56. The nanostructure of claim 48, wherein the nanostructure comprises a heterostructure having an aluminum core and a metal shell surrounding the core.

57. The nanostructure of claim 48, wherein the nanostructure comprises a substantially hollow shell formed by sacrificing the aluminum template material in the replacement reaction.

58. The nanostructure of claim 48, wherein the metal layer comprises one or more non-noble metals.

59. The nanostructure of claim 48, wherein the metal layer comprises nickel.

60. The nanostructure of claim 48, wherein the metal layer comprises cobalt.

61. The nanostructure of claim 48, wherein the metal layer comprises iron.

62. The nanostructure of claim 48, wherein the metal layer comprises at least one of zinc, gallium, cadmium, indium, lead, copper, tin, palladium, silver, platinum and gold.

63. The nanostructure of claim 48, wherein the metal layer comprises at least two different metals.

64. The nanostructure of claim 48, wherein the nanostructure has a surface area that is greater than about 28 m²/gram.

65. The nanostructure of claim 48, wherein the nanostructure has a surface area of between about 30 and 60 m²/gram.

66. A nanostructure, comprising:
a metal layer formed on a surface of a metal template material by a replacement reaction, the metal nanoparticle template having a redox potential that is less than −0.30 volts relative to the standard hydrogen electrode.

67. The nanostructure of claim 66, wherein the metal template material comprises at least one of aluminum, titanium, manganese, zinc, chromium and indium.

68-84. (canceled)
